(19) United States
(12) Patent Application Publication
(10) Pub. No.: US 2026/0277713 A1
(43) Pub. Date: Sep. 17, 2026

(54) CLOUD DATA PARTITIONING FOR A COMMUNICATION PLATFORM

(71) Applicant: Salesforce, Inc., San Francisco, CA (US)

(72) Inventors: Aaron M. Popelka, San Francisco, CA (US); Robert Phillips, Atlanta, GA (US); Craig Birchler, Indianapolis, IN (US); Jeanine Walters, San Francisco, CA (US)

(21) Appl. No.: 19/080,329

(22) Filed: Mar. 14, 2025

(51) Int. Cl. G06F 9/54; G06F 9/50

(52) U.S. Cl. CPC G06F 9/544; G06F 9/5016

(57) ABSTRACT

Techniques described include configuring an instance of a communication management application (e.g., an org) to utilize a non-default partition of a cloud data storage system, where the non-default partition may store data associated with user entities corresponding to the org. Techniques described herein also include configuring an org with multiple business units that each correspond to a respective partition. A user of an org may create one or more non-default partitions and may configure the org to utilize the non-default partition instead of a default partition. The user may also create one or more business units within the org and may cause each business unit to be configured to utilize a respective partition, such that data associated with user entities corresponding to each business unit may be stored in the respective partition. A user may also create a data object and assign the data object to a business unit.

### FIELD OF TECHNOLOGY

The present disclosure relates generally to database systems and data processing, and more specifically to cloud data partitioning for a communication platform.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, data storage systems for a communication management application may cause resource inefficiencies for one or more user devices (e.g., cloud clients) and a cloud data storage system. For example, one or more instances of a communication management application (e.g., one or more orgs) may utilize a single default data space (e.g., a default partition in a cloud data storage system) of the cloud data storage system for storing and accessing data associated with user entities (e.g., clients, buyers, customers) when performing one or more marketing operations, such as creating objects and transmitting electronic communications based on the objects. In some cases, the single default data space may reduce specificity in electronic communications and increase undesired electronic communications, wasting electronic communication resources (e.g., bandwidth, time resources), computational resources, and power resources for the one or more user devices or the cloud data storage system.

### BRIEF DESCRIPTION OF THE DRAWINGS

FIG. 1 illustrates an example of a data processing system that supports cloud data partitioning for a communication platform in accordance with aspects of the present disclosure.

FIG. 2 shows an example of a data system that supports cloud data partitioning for a communication platform in accordance with aspects of the present disclosure.

FIGS. 3A-3C show examples of user interfaces (UIs) that support cloud data partitioning for a communication platform in accordance with aspects of the present disclosure.

FIGS. 4A-4C show examples of UIs that support cloud data partitioning for a communication platform in accordance with aspects of the present disclosure.

FIGS. 5A-5D show examples of UIs that support cloud data partitioning for a communication platform in accordance with aspects of the present disclosure.

FIGS. 6A-6D show examples of UIs that support cloud data partitioning for a communication platform in accordance with aspects of the present disclosure.

FIG. 7 shows an example of a process flow that supports cloud data partitioning for a communication platform in accordance with aspects of the present disclosure.

FIG. 8 shows an example of a process flow that supports cloud data partitioning for a communication platform in accordance with aspects of the present disclosure.

FIG. 9 shows a block diagram of an apparatus that supports cloud data partitioning for a communication platform in accordance with aspects of the present disclosure.

FIG. 10 shows a block diagram of a data partition configuration module that supports cloud data partitioning for a communication platform in accordance with aspects of the present disclosure.

FIG. 11 shows a diagram of a system including a device that supports cloud data partitioning for a communication platform in accordance with aspects of the present disclosure.

FIGS. 12 and 13 show flowcharts illustrating methods that support cloud data partitioning for a communication platform in accordance with aspects of the present disclosure.

### DETAILED DESCRIPTION

A business (e.g., a company, an organization, a corporation, a single user) may utilize a communication management application (e.g., a marketing software, sales software, service management software, commerce software), to organize communication strategies with user entities (e.g., clients, customers, potential customers, business contacts). Organizing communication strategies may include generating objects and communicating with user entities based on the objects. For example, the objects may include communication flows (e.g., sets of logic or steps for electronic communications with a client, journeys), campaigns (e.g., groups of communication flows), content (e.g., used in the communication flows, such as emails, images, links), segments of user entities to receive electronic communications, and other data for marketing or customer relations purposes. In some cases, the business may utilize (e.g., own) multiple instances of the communication management application, which may be referred to as orgs. Each org may utilize data stored in a default data space. A data space may be a partition (e.g., a set of logical or physical memory locations) of a data storage system (e.g., a cloud data storage system), and a default data space may be automatically allocated and assigned to one or more orgs when the org is instantiated (e.g., set up, created). A data space may be referred to as a partition. In some cases, a default partition may store data associated with user entities (e.g., clients, customers, buyers, potential clients) that have interacted with the business, where the data may include names, addresses, email addresses, phone numbers, transaction histories, interaction histories, or other data associated with the user entities. Multiple users (e.g., employees, workers, managers, marketers, administrators) of the business may have access to an org through respective user devices and may create objects within the org to communicate with user entities based on the data stored in the default partition for the org.

In some cases, objects in an org may have access to all of the data in the default partition for the org, which may cause inefficiencies for a user, a user device used by the user, and/or the data storage system allocating the default partition. For example, a user may create a campaign to market to one or more segments, where a segment may be a set of one or more user entities defined by one or more common attributes based on the data stored in the default partition. In some cases, a segment may include all user entities in the default data space who have purchased an item and are located in North America. However, some user entities that satisfy the common attributes may not desire or are incompatible with one or more communications for the segment. That is, a user entity in the segment may be incompatible with one or more aspects of a campaign that communicates with the segment, such as a sub-category of the business (e.g., a brand, a product lines, a product type), a desired role of user entities, a geographical region, a language, or other aspects process flow the campaign. In one example, a user entity in a segment may be interested in a brand of the business other than the brand that a campaign is marketing, or may speak a language other than a language in which the campaign materials are defined. Accordingly, the user entity may be uninterested or unable to act on (e.g., incompatible with) communications associated with the campaign. Such disinterest or incompatibility may lead to retransmitting or discarding those communications, effectively wasting communication resources, processing resources, and power resources used at a user device or the data storage system to communicate with user entities.

According to techniques described herein, an org may be configured to utilize a non-default partition, an org may be configured with multiple business units that each correspond to a respective non-default partition, or both. In one example, a user of an org (e.g., an admin, a business owner, a leader in the business) may create one or more non-default partitions and may configure the org to utilize (e.g., store data in, access data from) the non-default partition instead of a default partition. Additionally, or alternatively, the user may create one or more business units within the org and may cause each business unit to be configured to utilize a respective partition (e.g., the default partition, a non-default partition), such that data associated with user entities corresponding to each business unit may be stored in the respective partition (e.g., separately from data associated with user entities corresponding to other business units). In some cases, a user may create a data object (e.g., a campaign, a segment, a communication flow, content) and assign the data object to a business unit of multiple business units associated with an org, such that one or more communications associated with the data object may be based on data from a partition corresponding to the assigned business unit. Additionally, after the object (e.g., a parent object) is assigned to a business unit, another object (e.g., a child object) created within the object may be assigned to the same business unit as the object (e.g., automatically).

Based on techniques described herein, users may more precisely define communication strategies and campaigns, which may allow for reduced communication, processing, and power resource usage at a user device or a data storage system. For example, assigning separate non-default data spaces to different orgs may allow for greater specificity in creating segments and campaigns (e.g., marketing campaigns, communication strategies). Higher specificity may reduce unwanted, unrelated, or incompatible electronic messaging. Similarly, creation of business units within an org, where each business unit is associated with a respective data space, may increase a specificity for campaigns and reduce electronic messaging (e.g., reduce a quantity of electronic messages transmitted to achieve the same profitability). Reducing electronic messaging may reduce wasted transmission resources (e.g., bandwidth, time resources), wasted power resources, and wasted computational resources at user devices and the data storage system. Additionally, UIs described herein allow for an improved user interface on a user device for creating specific and targeted campaigns, further reducing user device power and computational resources to configure such campaigns. For example, current UIs for communication management applications may not allow for creation, provisioning, and management of multiple partitions or business units within a cloud data storage system. Organizing such specific storage in multi-user cloud based applications (e.g., communication management applications) may not be trivial, and thus the UIs described herein may provide an improved UI for a user device that allows for increased accuracy and efficiency in electronic communication.

Aspects of the disclosure are initially described in the context of an environment supporting an on-demand database service. Aspects of the disclosure are also described in the context of data systems, process flows, and user interfaces (UIs). Aspects of the disclosure are further illustrated by and described with reference to apparatus diagrams, system diagrams, and flowcharts that relate to cloud data partitioning for a communication platform.

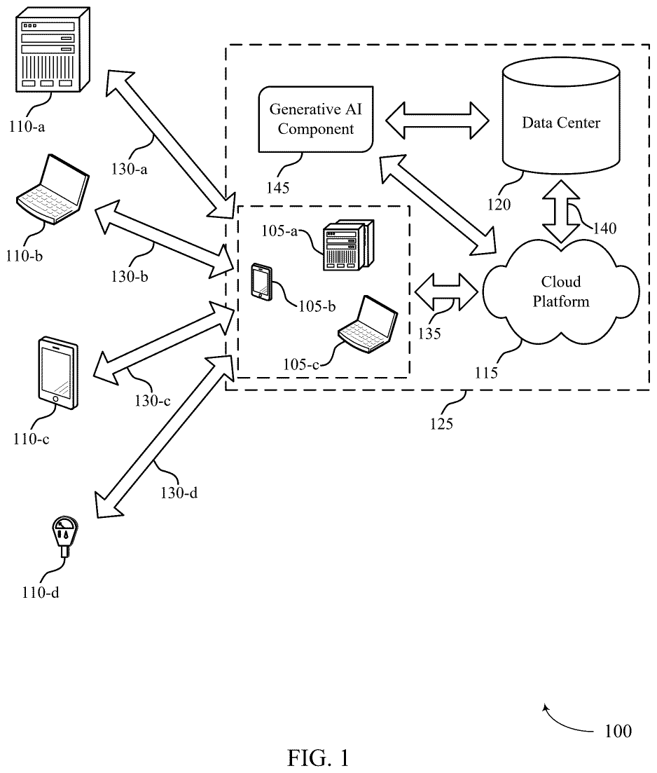

FIG. 1 illustrates an example of a system 100 for cloud computing that supports cloud data partitioning for a communication platform in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with the same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Further, the AI technologies may be merged in a variety of implementations, for example, by bagging, boosting, stacking, etc. the AI technologies.

In some cases, one or more cloud clients 105 may be associated with one or more instances of a communication management application (e.g., one or more orgs). For example, a user may utilize one or more cloud clients 105 to access the orgs and manage electronic communications with user entities (e.g., clients, customers, potential customers). In some cases, the orgs may store data in a cloud data storage system, which may include the cloud platform 115, the data center 120, or both. For example, the cloud data storage system may store data associated with user entities (e.g., personal data, transaction or interaction history, demographic information) in a default data space (e.g., default partition) for one or more orgs. In some cases, one or more orgs may share the same default partition within the cloud data storage system, which may be a partition of the cloud data storage system configured to store data for the orgs.

In some cases, storing data associated with user entities for one or more orgs in a single default partition may reduce specificity in electronic communications and lead to inefficiencies in resource usage at the cloud clients 105, the cloud data storage system, or both. For example, a user may use the communication management application to organize and effectuate electronic communication with user entities based on the user entity data stored in the default data space. However, if the default data space includes information from one or more user entities not well-related to the org or a campaign being employed through the electronic communications, one or more electronic communications may be unwanted, disregarded, or incompatible with the user entity. For example, the electronic communications may be regarding a brand or product offered by a business, but if the user entity is not interested in or has no use for such a brand or product, the user entity may disregard or not utilize the electronic communication. Additionally, or alternatively, if one or more electronic communications are in a first language or are related to a geographical location and the user entity only speaks a second language or resides in a different geographical location, the user entity may disregard the electronic communication as being incompatible with the user entity. Transmitting such unwanted or incompatible electronic communications may utilize communication resources (e.g., bandwidths, time resources), power resources, and computational resources at the cloud clients 105, the cloud data storage system, or both. For example, transmitting an email or text message from a cloud client 105 may use power resources and communication resources (e.g., wireless, wired), and accessing the data to create such an electronic communication may use power and computational resources at the cloud client 105, the cloud data storage system, or both.

According to techniques described herein, a communication management application may implement one or more techniques to reduce wasted communication, power, and computational resources associated with unwanted or incompatible electronic communications. For example, the techniques described herein may allow a user of an org to configure the org to utilize a non-default data space (e.g., non-default partition), which may allow the org to effectuate electronic communications based on data associated with user entities that are more specifically associated with the org, such that the electronic communications may be more accurate for, wanted by, and compatible with the recipient user entity. Additionally, or alternatively, an org may be configured to include one or more business units, where each business unit may be configured to utilize a respective partition that stored data associated with the business unit. Such business units may also be associated with more specific and accurate electronic communications based on the data from the corresponding data spaces, reducing wasted communication resources, power resources, and computational resources at the cloud client 105, cloud data storage system, or both.

Additionally, or alternatively, one or more UIs may be used to create, share (e.g., provision) and manage data spaces and business units. In some cases, such UIs may allow a user (e.g., an administrative user) of an org (e.g., a home org) to share a data space with a related org (e.g., a companion org), set an access level of one or more orgs for one or more data spaces, set an access level of one or more users for one or more business units, or any combination thereof. Additionally, one or more UIs described herein may allow a user to configure orgs and business units to utilize respective data spaces (e.g., partitions), and may allow a user to create one or more objects within an org or business unit and to utilize the data from the data space corresponding to the org or business. Some communication management applications may not allow a user to create, manage, and share data spaces or business units, which may not be a trivial feature to implement in a multi-user cloud-based system. Thus, the UIs described herein may provide an improved UI for a user device that provides improved coordination in cloud data storage and use to reduce wasted resources.

As an example, a business may offer products under a first brand suited for a first set of user entities and a may offer products under a second brand suited for a second set of user entities. In some cases, one or more characteristics of the first set of user entities may be different from one or more characteristics of the second set of user entities (e.g., gender, language, socioeconomic status, purchase history, geographic location, employment). In some cases, electronic communications meant for marketing the products under the first brand may be unwanted by or incompatible with the second set of user entities, and vice versa. In some communication management applications, the business may use a single default data space to store data associated with the first set of user entities and the second set of user entities, which may result in using resources to create and transmit electronic communications that are unwanted or incompatible with the recipient. However, according to techniques described herein, the business may instantiate two orgs, where each org is associated with a respective brand and configured to utilize a respective non-default data space. For example, a first org may be associated with the first brand, and the corresponding data space may store data associated with the first set of user entities (e.g., and not the second set of user entities). Additionally, or alternatively, the business may create two business units within a single org, where each business unit is associated with a respective brand and is configured to utilize a respective data space. For example, a first business unit may be associated with the first brand and the corresponding data space may store data associated with the first set of user entities. Accordingly, electronic communications designed for the first brand may be sent exclusively to user entities identified in the first data space, reducing wasted resources from unwanted or incompatible electronic communications. Additionally, or alternatively, the business may create and manage the data spaces or business units within the communication management system with one or more improved UIs described herein.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

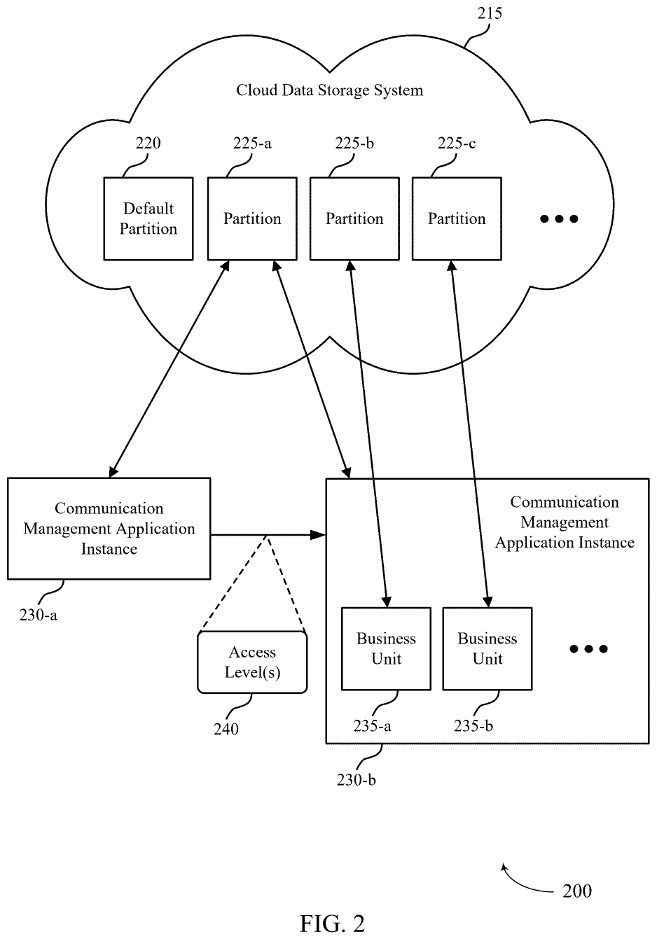

FIG. 2 shows an example of a data system 200 that supports cloud data partitioning for a communication platform in accordance with aspects of the present disclosure. In some cases, aspects of the data system 200 may implement or be implemented by aspects of FIG. 1. For example, the data system 200 may include a cloud data storage system 215, which may be an example of the cloud platform 115, data center 120, or both, as described herein with respect to FIG. 1. In some aspects, the cloud data storage system 215 may include a default partition 220 (e.g., a default data space) and one or more partitions 225 (e.g., non-default data spaces), where one or more orgs 230 (e.g., instances of a communication management instance) may be configured to utilize one or more partitions 225 other than the default partition 220. Additionally, each org 230 may include one or more business units 235, where each business unit 235 may be configured to utilize one or more partitions of the cloud data storage system 215.

In some cases, the cloud data storage system 215 may include aspects of the cloud platform 115, the data center 120, or both, a described with respect to FIG. 1. For example, the cloud data storage system 215 may be supported by one or more servers collecting, storing, and outputting data. Additionally, the cloud data storage system 215 may receive and handle data similarly to the cloud platform 115, including data associated with user entities, such as interaction histories, personal data, or other data. In some cases, the cloud data storage system 215 may support a communication management application by storing and managing data used for electronic communications between a business and one or more user entities (e.g., customers, potential customers, clients) via the communication management application.

The communication management application may include a set of software and UIs that assist a business in managing electronic communications with user entities. For example, a communication management application may be an example of a CRM solution, and may include software designed to organize communications for marketing, sales, commerce, services, or other client relation communications. In some cases, a business may utilize the communication management application to create objects that affect electronic communications with user entities. Such objects may include content (e.g., emails, graphics, text, videos, sounds), communication flows (e.g., sets of actions for communicating content with user entities where each action is linked to another action though logical pathways or steps), campaigns (e.g., sets of communication flows), and segments (e.g., a set of user entities defined by one or more attributes common to all user entities in the set). Various members of a business may have profiles within the communication management application and may serve different roles in the communication management application, such as administrative users, marketers, or others.

In some cases, a business may utilize different instances of the communication management application, where each instance may be referred to as an org 230. For example, two orgs 230 owned by the same business may differ in one or more settings, one or more users who can access the org, or other features. Two orgs 230 owned by the same business may share the same cloud client (e.g., one instance of the cloud data storage system 215). For example, in some cases, multiple orgs owned by the same business may utilize the same default partition 220 to store and manage data associated with all user entities associated with each org. For example, a business may be made of two sub-businesses selling different products or services. In some cases, the business may own a first org associated with a first sub-business and a second org associated with a second sub-business, where data associated with user entities for both sub-businesses may be stored in the same default partition 220. However, in one example, combining such data in a single default partition 220 may lead to one sub-business sending electronic communications to user entities associated with the other sub-business. If the products sold by the sub-businesses are sufficiently different, or user entities of one sub-business are not compatible with products for the other sub-business (e.g., of different genders, speak different languages, of different respective roles or positions in companies), some electronic communications may be disregarded, unwanted, or obsolete. Accordingly, communication resources, power resources, and computational resources expended to transmit such electronic communications are wasted at the server, user device, or data storage system used to transmit them.

According to techniques described herein, the cloud data storage system 215 may include one or more partitions 225 (e.g., data spaces) other than the default partition 220, where each org 230 may be configured to utilize one or more respective partitions 225. For example, an org 230-a may be configured to utilize a partition 225-a of the cloud data storage system 215, such that data associated with user entities that correspond to the org 230-a may be stored and accessed in the partition 225-a separately from data associated with user entities that correspond to an org 230-b. Such configuration may include downloading one or more data kits to configure an org 230 to access the partition 225, as well as setting one or more parameters within the communication management application to reference the partition 225. In some cases, an org 230 may be configured to utilize a respective and separate partition 225, or may be configured to utilize a same partition 225 as another org 230. For example, org 230-a and 230-b may both be configured to utilize partition 225-a, or may be configured to utilize different partitions 225 (not shown).

A partition 225 (e.g., a non-default partition) may differ from a default partition 220 in various ways. For example, a partition 225 may be allocated separately from an instantiation of an org 230. That is, when an org 230 is instantiated (e.g., a cloud client profile is created and given access to a new instance of the communication management application), the default partition 220 may be automatically allocated within the cloud data storage system 215 for the purpose of storing and managing data for the org 230. However, a partition 225 may be created (e.g., allocated) before or after the instantiation of an org 230 and provisioned to the org 230 after instantiation (e.g., and after creation of the default partition 220). Additionally, partitions 225 may be associated with one or more identifiers indicating a purpose other than general purpose, such as a specific set of user entities for which the partition 225 is to store data.

Orgs 230 may be associated with one another, such that one cloud data storage system 215 may be used for each org 230 (e.g., without separate cloud client profiles). In some cases, one org 230, such as the org 230-a, may be referred to as a home org, and other orgs 230 created later or from the home org, such as an org 230-b, may be referred to as companion orgs. In some cases, a home org may provision partitions 225 to the companion orgs, and a user of the companion org may select a partition 225 to assign to the companion org (e.g., to configure the companion org to utilize). In some cases, home orgs may have access to one or more administrative or managerial actions not accessible to companion orgs, such as setting access levels for users or orgs, creating new orgs, partitions, or business units, or other actions.

One exemplary technique for provisioning partitions 225 to companion orgs may include setting one or more access levels 240 of a companion org for each partition 225. For example, a first user (e.g., an administrative user) of the org 230-a may set an access level 240 of the org 230-b for partition 225-b and partition 225-c such that the org 230-b is capable of accessing and utilizing one or more of the partition 225-b and the partition 225-c. However, the first user may set an access level 240 of the org 230-b for the partition 225-a such that the org 230-b is not capable of utilizing the partition 225-a. Additionally, or alternatively, the access levels 240 may be set for each user with respect to each partition 225. For example, if a user has access to the partitions 225-b and the partition 225-c and has access to the org 230-b (e.g., is an administrator of the org 230-b), the org 230-b may have access to the partition 225-b and the partition 225-c. Such techniques for setting access levels 240 may further be applicable to default partitions 220, partitions 225, and business units 235, or any combination thereof.

An org 230 may also include one or more business units 235. For example, the org 230-b may include a business unit 235-a and a business unit 235-b. Each business unit may be configured to utilize a respective partition 225, which may be the same or different from partitions 225 utilized by other business units 235 within one org 230. Additionally, each business unit 235 may be configured to utilize one or more content management resources (e.g., content management system (CMS) workspace), which may be a separate partition of the cloud data storage system 215 used to store and manage content associated with a business unit 235, such as graphics, logos, videos, sound clips, or other content. Business units 235 may be configured to utilize a partition 225 that is accessible to the org 230 to which the business unit belongs. Additionally, a user of the org 230-a or the org 230-b (e.g., an administrative user) may set access levels of each user of the org 230-b for each business unit 235 within the org 230-b (e.g., as described herein).

Greater specificity and accuracy may be achieved in electronic communications associated with the orgs 230 based on the techniques described with respect to FIG. 2. For example, by configuring each org 230 to utilize a respective partition 225 to store and manage data associated with corresponding user entities, electronic communications (e.g., emails, texts, voice calls, video calls) may be directed to user entities in a more accurate fashion. For example, fewer user entities that are not interested or incompatible with the electronic communications may receive electronic communications from the orgs 230. Similarly, electronic communications associated with business units may be more specific and accurate. Electronic communications may utilize communication resources, power resources, and computational resources of user devices and cloud data storage servers, and thus transmitting fewer unwanted or incompatible electronic communications based on partitions 225 and business units 235 described herein may conserve resources for one or more electronic devices.

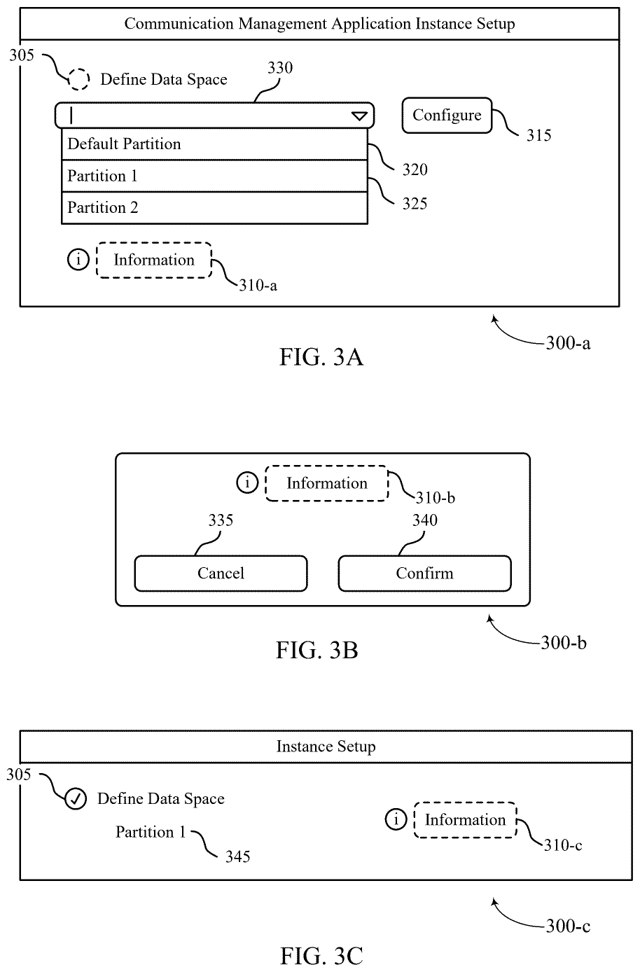

FIG. 3A-3C show examples of UIs 300 that support cloud data partitioning for a communication platform in accordance with aspects of the present disclosure. In some cases, aspects of the UIs 300 may implement or be implemented by aspects of FIGS. 1 and 2. For example, FIG. 3A may include a UI 300-a for assigning a partition 325 (e.g., a data space) to an org (e.g., an org 230), FIG. 3B may include a UI 300-b for confirming the assignment of the partition to the org, and FIG. 3C may include a UI 300-c for indicating that the org is configured to utilize the partition 325. In some aspects, using the UIs 300 may reduce a quantity of wasted resources at one or more user devices or servers associated with unwanted or incompatible electronic communications.

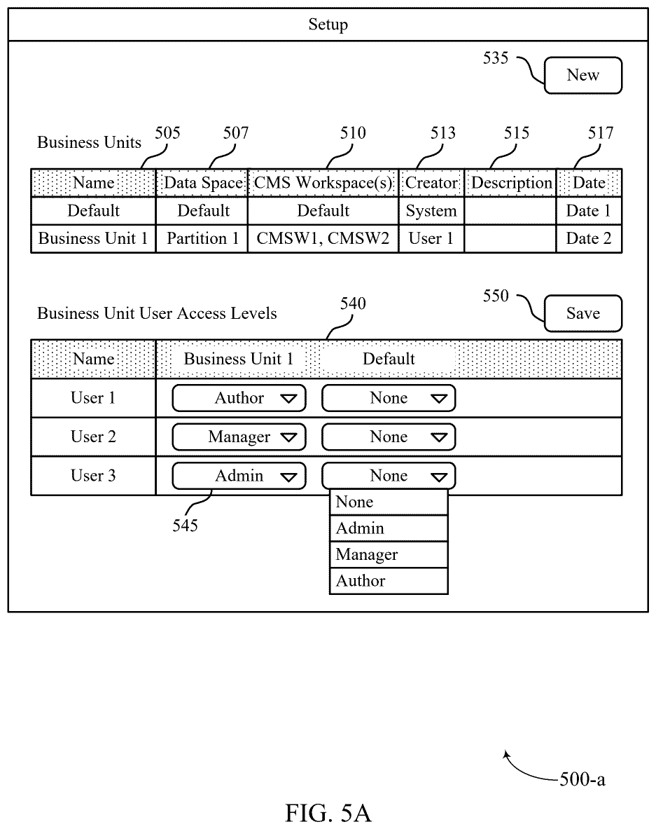

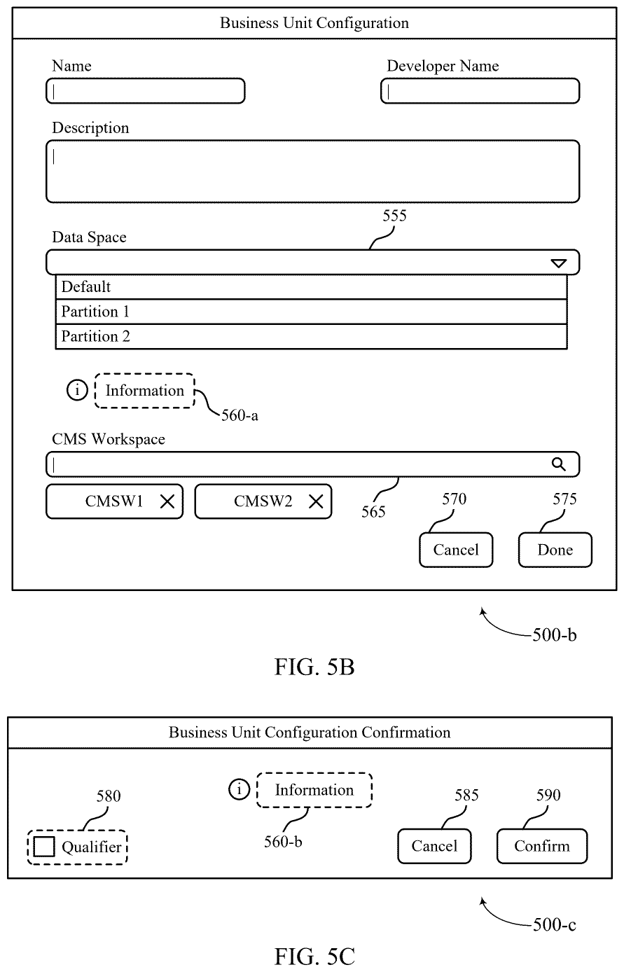

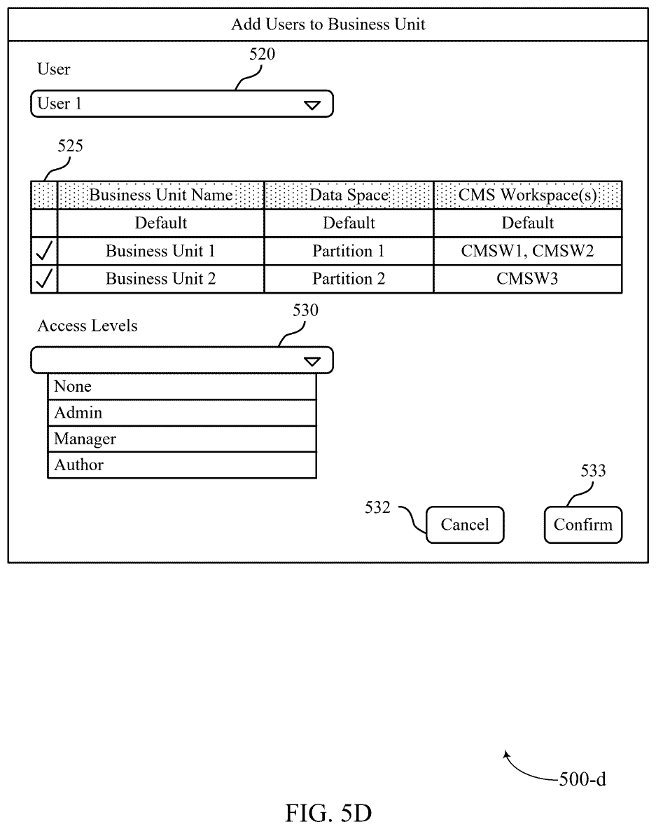

In some cases, a cloud client (e.g., the cloud clients 105 described herein with respect to FIG. 5, a user device) may display one or more UIs described with respect to FIGS. 3A-6D via a display component (e.g., screen) of a user device to a user associated with an org (e.g., a communication management application instance). For example, a UI described herein may be displayed exclusively, or one or more UIs described herein may be displayed simultaneously, overlapping, or otherwise together. In some cases, such display may include receiving an indication of the UI to display from another cloud client (e.g., a server). The UIs illustrated in FIGS. 3A-6D may be exemplary, and may include one or more other features, or one or more features shown in FIG. 3A-6D may not be present. That is, a UI component displayed on any display component that accomplishes one or more of the features described herein may be covered by the UIs described herein.

A cloud client may display the UI 300-a for a user to select or indicate a partition to set as a data space for an org. For example, the UI 300-a may include a partition indication field 330 which may allow the user to select or input a partition 325 to assign to the org (e.g., to cause the org to be configured to utilize). In some cases, the partition indication field 330 may include a drop down menu to select from a default partition 320 and one or more partitions 325 that are accessible to the org. Additionally, or alternatively, the partition indication field 330 may include a text input field for the user to type or insert a name or other identifier of a partition 325. In some cases, the available partitions may include a default partition 320, one or more partitions 325 (e.g., non-default partitions), or a combination thereof.

In some cases, the UI 300-a may include one or more other features. For example, the UI 300-a may display a defined data space indication 305, where one state of the define data space indication 305 may indicate that a partition has not been selected as the data space for the org and another state of the define data space indication 305 may indicate that a partition has been selected and the org has been configured to utilize the selected partition.

Additionally, or alternatively, the UI 300-a may display some information 310-a. For example, the information 310-a may indicate that more partitions may be created, provide a link to resources to learn more about partitions and the use thereof, indicate a permanent nature of configuring an org to utilize a partition, or any combination thereof. Additionally, or alternatively, the UI 300-a may include a configure button 315, which the user may select (e.g., click, push, tap) to enter the selected partition. In some cases, buttons described herein may include any input feature that requests an action by the UI, including key presses.

In response to selecting the configure button 315 after selecting a partition in the partition indication field 330, the cloud client may display a UI 300-b to the user associated with the org. For example, the UI 300-b may include information 310-b and allow the user to select a confirm button 340 or a cancel button 335 associated with the selection of the partition 325 in the partition indication field 330. For example, the information 310-b may indicate a permanent nature of configuring an org to utilize a partition 325 (e.g., or the default partition 320), display a link to more information about partitions, or both. Selecting the cancel button 335 may return the user to the UI 300-a (e.g., may cause the cloud client to display the UI 300-a again), and selecting the confirm button 340 may cause the cloud client to display a UI 300-c to the user.

The UI 300-c may indicate the second state of the defined data space indication 305 that indicates that the org has been configured to utilize the partition indicated in the partition indication field 330. For example, in response to selecting the confirm button 340 in the UI 300-b, the cloud client may automatically configure the org to utilize the partition 325. Additionally, or alternatively, the cloud client may request, in response to the user selecting the confirm button 340, one or more user inputs to configure the org to utilize the partition 325 (e.g., selecting one or more data kits to download, locations for downloading, or other configuration steps). The UI 300-c may also include a partition indication field 345 to indicate the partition 325 that the org was configured to utilize, and may include information 310-c, which may be similar to information 310-a.

Configuring the org to utilize the indicated partition 325 may include one or more background or foreground operations. For example, configuring the org to utilize the partition 325 may include downloading (e.g., manually or automatically) one or more data kits associated with the partition, the org, or both. Configuring the org to utilize the partition 325 may also include setting one or more data paths within the communication management application, setting one or more parameters that link the org to the partition, and/or one or more other “permanent” changes that would cause unresolvable or extensive errors in the org if reverted.

Configuring an org to utilize a partition 325 other than the default partition may allow the org to access data curated to a more specific set of user entities, reducing waste in communication resources, power resources, and computational resources associated with unwanted or incompatible electronic communication. Additionally, some communication management applications do not include a UI to allow such beneficial configurations of orgs and partitions, and thus the UIs 300 include improved UIs for a user device.

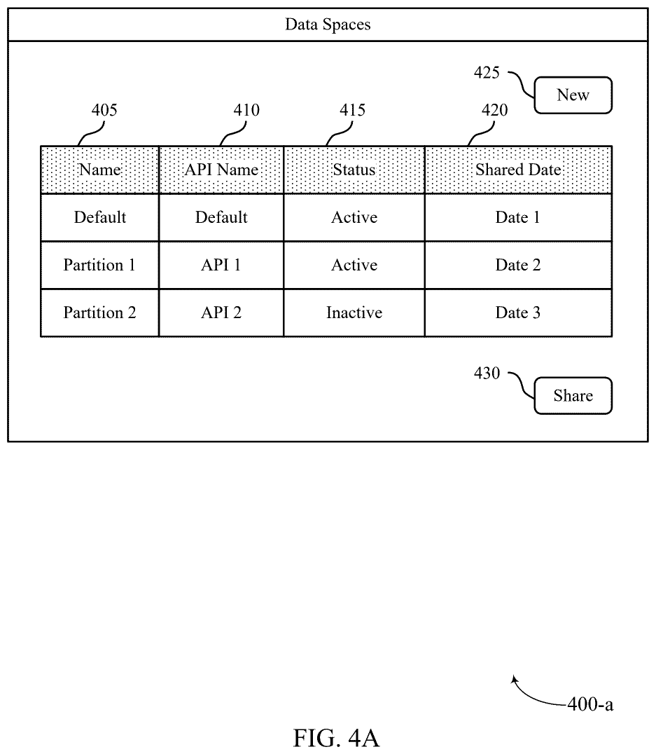

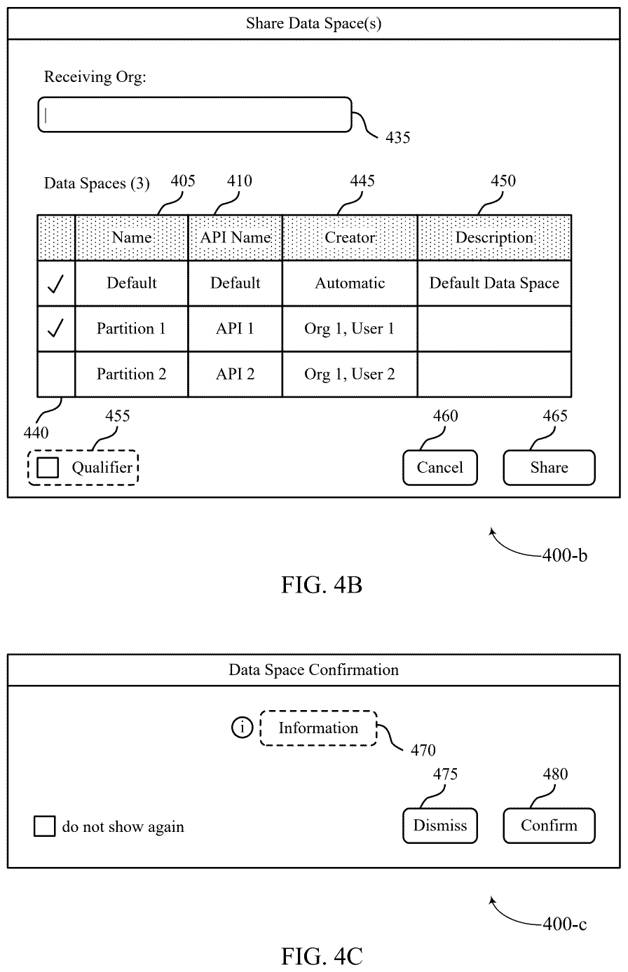

FIG. 4A-4C show examples of UIs 400 that support cloud data partitioning for a communication platform in accordance with aspects of the present disclosure. In some cases, aspects of the UIs 400 may implement or be implemented by aspects of FIGS. 1-3. For example, FIG. 4A may include a UI 400-a for displaying partitions, FIG. 4B may include a UI 400-b for sharing (e.g., provisioning, allowing access to) partitions for one or more orgs, and FIG. 4C may include a UI 400-c for a user of an org that is being provisioned with a partition (e.g., a companion org) to confirm the provisioning. In some aspects, using the UIs 400 to share (e.g., provision) partitions with orgs may reduce a quantity of wasted resources at one or more user devices or servers associated with unwanted or incompatible electronic communications.

In some cases, a cloud client of a first org (e.g., a home org, a companion org) may display the UI 400-a to a user to indicate one or more partitions and information associated with each partition. For example, the UI 400-a may indicate names 405 for one or more partitions (e.g., including a default partition, one or more non-default partitions, or both), application programming interface (API) names 410 for the one or more partitions, statuses 415 of the one or more partitions, a shared date 420 of the one or more partitions, or any combination thereof. In some cases, the partitions with a status 415 of active may be capable of syncing updates to the partition (e.g., updated name, data storage system location, available storage space, data stored in the partition) with orgs with whom the partition has been shared. The shared date 420 may indicate data that the first org shared (e.g., provisioned) the partition to one or more other orgs (e.g., companion orgs), and may indicate the one or more other orgs. In some cases, data from objects in the shared partitions may be accessible to the first org (e.g., a home org) and the orgs with whom the partition was shared (e.g., provisioned, companion orgs).

The UI 400-a may also include a new button 425. For example, if the user selects the new button 425, the cloud client may display a UI (not shown) for the user to create a new partition. In some cases, creating a new partition may include indicating a name 405, a description, an API name 410, a status 415, or other information about the new partition. Creating the new partition may transmit a request to the cloud data storage system to allocate storage space for a new partition within the cloud data storage system.

The UI 400-a may include a share button 430 (e.g., a provision button). In response to the user selecting the share button 430, the cloud client may display the UI 400-b for the user of the first org to share (e.g., provision) one or more partitions with one or more second orgs (e.g., companion orgs). For example, the UI 400-b may include a receiving org input field 435, where a user may input an org ID or select an org ID from a drop down list of org IDs known to the first org. The org ID inputted into the receiving org input field 435 may indicate the recipient (e.g., one of the second orgs) of the shared one or more partitions. The UI 400-b may further include indications of one or more partitions, including names 405 of the one or more partitions, API names 410 for the one or more partitions, creators 445 of the one or more partitions (e.g., an org, a user, both), a description 450 of the partition, or any combination thereof.

Additionally, the UI 400-b may include a selection field 440 for each partition, which may allow the user to select partitions to share with the second org indicated in the receiving org input field 435. For example, each selection field 440 may be in a state indicating that the partition will be shared (e.g., with a check mark) or in a state indicating that the partition will not be shared (e.g., blank). Additionally, the UI 400-b may include a qualifier 455 which may be selected to allow a user to share the indicated partitions. For example, the qualifier may indicate that the user understands that data stored in shared partitions is synchronized between orgs with whom it is shared. The UI 400-b may also include a cancel button 460 and a share button 465 to return to the UI 400-a and to share the indicated partitions with the indicated org, respectively.

Additionally, or alternatively, one or more partitions may be shared with one or more orgs by setting access levels of the one or more orgs for each of the partitions in a grid of access level indication fields. For example, similar to what is shown in FIG. 5A, a table where each row indicates an org and each column indicates a partition (e.g., or vice versa) may include fields to set an access level of each org with respect to each partition, and orgs set to access levels that satisfy a threshold level for a partition may be provisioned with the partition.

A second org to which a partition is being provisioned (e.g., shared) may confirm or dismiss provisioning of the partition. For example, a cloud client associated with the second org may display (e.g., on a user device to a user associated with the second org) the UI 400-c, which may provide the user with a confirm button 480 to confirm the provisioning and a dismiss button 475 to dismiss (e.g., reject, deny) the provisioning. In some cases, displaying the UI 400-c and receiving input from the user of the second org using the dismiss button 475 or the confirm button 480 may occur on a first or initial provisioning of a partition from the first org to the second org (e.g., as part of a handshake procedure), and may not occur for subsequent provisioning of partitions from the first org to the second org. Additionally, the UI 400-c may include information 470, which may indicate the first org that is sharing the partition, a description of the partition being shared, a date that the partition was shared, or any combination thereof.

In some cases, displaying, managing, and sharing partitions as described with respect to FIGS. 4A through 4C may provide one or more technical advantages for a cloud client, user device, or data storage system. For example, allowing orgs to utilize partitions other than a default partition may increase specificity and accuracy in electronic communications from the orgs to user entities, which may reduce unwanted or incompatible electronic communications and thus reduce communication resource waste, power resource waste, and computational resource waste at a user device, server, or data storage system. Additionally, or alternatively, some communication management systems may not provide UIs to create, manage, or provision partitions other than a default partition, and such operations may not be trivial within a multi-user cloud based system. Thus, the UIs 400 may represent improved user interfaces for user devices to effectuate electronic communications in a precise and accurate manner.

FIGS. 5A-5D show examples of UIs 500 that support cloud data partitioning for a communication platform in accordance with aspects of the present disclosure. In some cases, aspects of the UIs 500 may implement or be implemented by aspects of FIGS. 1-4. For example, FIG. 5A may include a UI 500-a for managing business units and access levels to business units, FIG. 5B may include a UI 500-b for creating (e.g., configuring) a business unit, FIG. 5C may include a UI 500-c for confirming business unit configurations, and FIG. 5D may include a UI 500-d for adding users of an org to a business unit. In some aspects, business unit creation and configuring using the UIs 500 may reduce a quantity of wasted resources at one or more user devices or servers associated with unwanted or incompatible electronic communications.

In some cases, an org may be configured to include one or more business units. where a business unit may be defined by a combination of a partition in the cloud data storage system and one or more content management resources. In some cases, a content management resource may be referred to as CMS workspaces, and may be a separate partition within the cloud data storage system for storing content associated with a business unit or org. In some cases, a cloud client associated with an org may display the UI 500-a to a user of the org, where the UI 500-a may indicate information about one or more business units of the org. For example, the UI 500-a may display names 505 of the business units, data spaces 507 (e.g., partitions) of the business units, CMS workspace(s) 510 of the business units, a creator 513 of each business unit, a description 515 of each business unit, a creation date 517 of each business unit, or any combination thereof. In some cases, the one or more business units may include a default business unit, which may be a business unit generated for the org at instantiation of the org.

The UI 500-a may also include an access level table 540 for setting access levels of one or more users of the org for each business unit of the org. For example, each row of the table may correspond to a user associated with the org, and each column may correspond to a business unit of the org (e.g., or vice versa), and an access level indication field 545 may indicate an access level of a user for a business unit. For example, the access level indication field 545 may indicate that the user 3 has an access level of “Admin” with respect to business unit 1. In some cases, the access level indication fields 545 may be drop down menu input fields, text input fields, or other input fields.

The access levels may include a set of predetermined access levels. For example, the access levels may include “None” (e.g., not allowed to access the business unit), “Admin” (e.g., capable of performing administrative operations associated with the business unit, such as publishing new content), “Manager” (e.g., capable of performing managerial operations associated with the business unit, such as publishing new content), “Author” (e.g., capable of creating new content for or within the business unit), other access levels, or any combination thereof. After using the access level table 540 to set the access levels of the users of the org with respect to each business unit, a user (e.g., an administrative user) may select a save button 550 to save (e.g., store) the access level of each user of the org.

The UI 500-a may include a new button 535 for creating new business units. For example, if the user selects the new button 535, the cloud client may display the UI 500-b to the user for configuring a new business unit. The UI 500-b may include a partition indication field 555 to indicate a partition to assign to the business unit. For example, the partition indication field 555 may be similar to the partition indication field 330 as described herein with respect to FIG. 3A, but may indicate a partition to assign to a business unit instead of to an org. Information 560-a may also indicate to the user that the partition selected in the partition indication field 555 cannot be changed after creation of a business unit (e.g., after selecting a done button 575 in the UI 500-b). The UI 500-b may also include one or more other input fields, which may include a name field, a developer name field, a CMS workspace field 565, a cancel button 570, and the done button 575. In some cases, the CMS workspace field 565 may accept text input to indicate a CMS workspace, a drop down menu, or the UI 500-b may suggest available CMS workspaces (e.g., CMSW1, CMSW2) to be selected. Additionally, or alternatively, the one or more other input fields may include a physical address field (e.g., a street address associated with the business unit), which may inherit (e.g., be set to by default, automatically be set to) a physical address associated with the user (e.g., a tenant address), but may be updated in the physical address field of the UI 500-b. The user may select the cancel button 570 to return to the UI 500-a or select the done button 575 to finish configuring the new business unit according to the one or more inputs selected in the UI 500-b.

In response to selecting the done button 575, the cloud client may display the UI 500-c to the user, which may request a confirmation to configure the new business unit to utilize the partition indicated in the partition indication field 555. For example, information 560-b in the UI 500-c may indicate the permanent nature of configuring the new business unit to utilize the indicated partition, and a qualifier 580 may cause the user to acknowledge the information 560-b before selecting a confirm button 590 of the UI 500-c. Additionally, or alternatively, the UI 500-c may include a cancel button 585, which may return the user to the UI 500-b.

In some cases, the UI 500-d may illustrate an alternate method of setting user access levels for business units within an org. For example, a cloud client may display the UI 500-d to a user of the org (e.g., an administrative user of the org), and the user may set an access level of one or more users using the UI 500-d. For example, the UI 500-d may include a user indication field 520 (e.g., a drop down menu, a text input field), business unit selection fields 525, and an access level indication field 530. If the user selects a confirm button 533 in the UI 500-d, any user(s) indicated in the user indication field 520 may be set to the access level indicated in the access level indication field 530 for the business units indicated by the business unit selection fields 525. Additionally, or alternatively, the user may select the cancel button 532 to return to a different UI, such as the UI 500-a.

In some cases, configuring and managing access to business units using the UIs 500 may reduce resource waste due to unwanted or incompatible electronic communications by increasing specificity and accuracy in the user entities that receive the electronic communications. Additionally, or alternatively, the UIs 500 may provide an improved UI for a user device by allowing users to create and manage business units, which is a non-trivial task in a multi-user cloud based system.

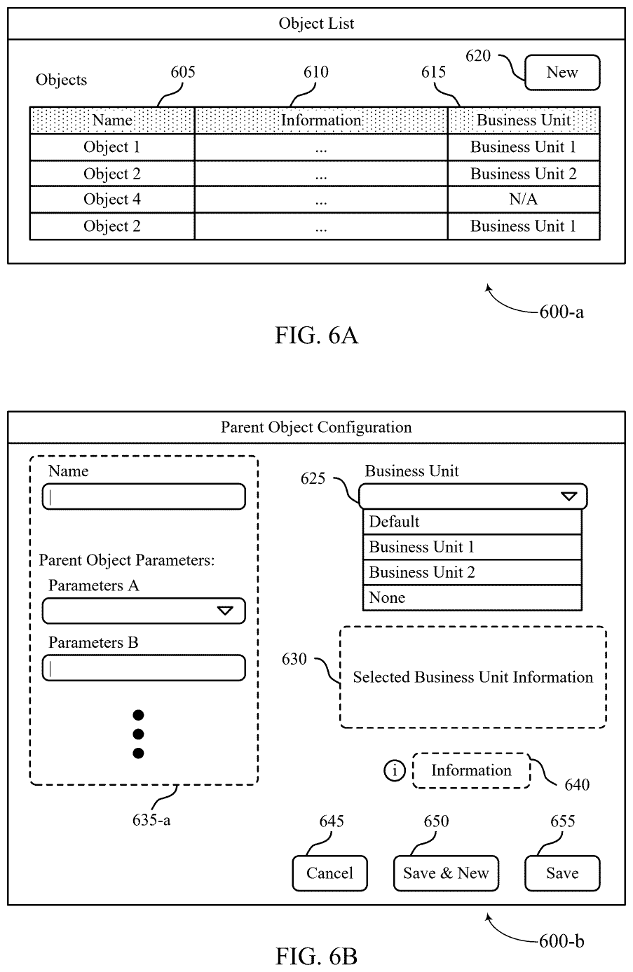

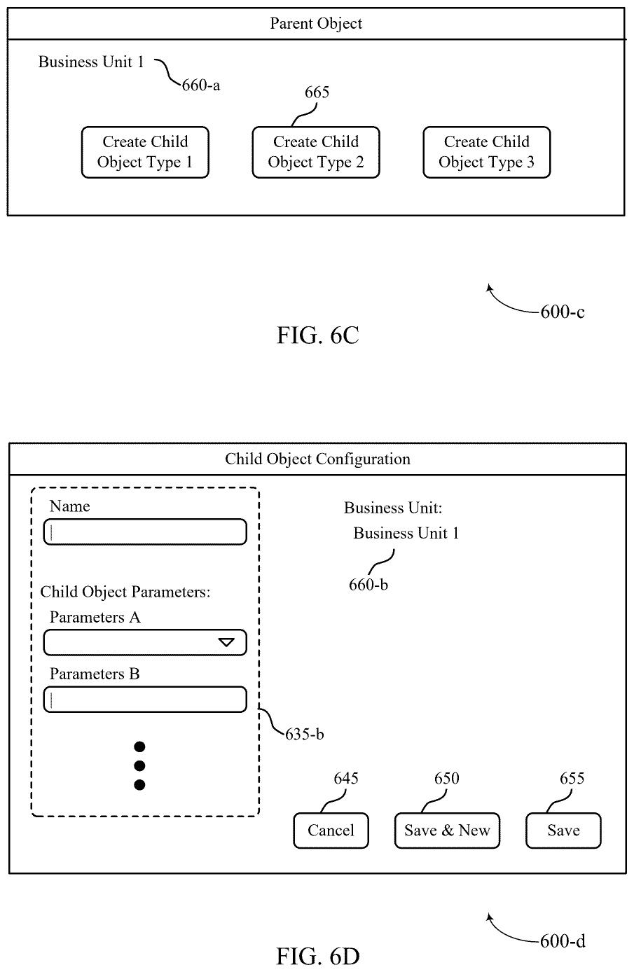

FIG. 6A-6 show examples of UIs 600 that support cloud data partitioning for a communication platform in accordance with aspects of the present disclosure. In some cases, aspects of the UIs 600 may implement or be implemented by aspects of FIGS. 1-5. For example, FIG. 6A may include a UI 600-a for displaying objects within an org, FIG. 6B may include a UI 600-b for creating new objects (e.g., parent objects) within an org, FIG. 6C may include a UI 600-c for selecting an object (e.g., child objects) to create within an object (e.g., a parent object), and FIG. 6D may include a UI 600-d for creating the child object within the parent object. In some aspects, creating objects within a business unit using the UIs 600 may reduce a quantity of wasted resources at one or more user devices or servers associated with unwanted or incompatible electronic communications.

A cloud client may display the UI 600-a to a user associated with a first org to display one or more objects within the first org. For example, the UI 600-a may indicate a name 605 of the one or more objects, information 610 of the one or more objects, a business unit 615 associated with the one or more objects, or any combination thereof. In some cases, the one or more objects may include objects that are associated with business units 615 that are accessible to the first org (e.g., as described herein with respect to FIGS. 5A and 5D). In some cases, the information 610 may include dates relevant to the object (e.g., creation date, start date, end date), a type of the object, a status of the object, a cost of the object, or other information.

In some cases, each business unit 615 displayed in the UI 600-a may be a business unit accessible to the first org, a business unit not accessible to the first org, or may not indicate a business unit (e.g., “N/A” or blank). For example, some objects may be created without being associated with a business unit, and such objects may be created within the org by utilizing a partition associated with the org instead of any partition associated with a business unit.

The UI 600-a may include a new button 620 for the user to create a new object within the org. For example, in response to the user selecting the new button 620, the cloud client may display the UI 600-b for the user to configure (e.g., create) an object. In some cases, if the object is a parent object (e.g., not created within any other object), the UI 600-b may include a business unit indication field 625 for the user to indicate a business unit associated with the object. As each business unit corresponds to a respective partition, indicating a business unit in the business unit indication field 625 also indicates a partition that the object may utilize.

The UI 600-b may include other fields 635-a, information 640, and buttons. For example, the UI 600-b may include the fields 635-a for configuring the object. In some cases, the fields 635-a may include a name field and one or more other parameter input fields (e.g., parameter A, parameter B), which may be text input fields, drop down fields, numerical input fields, or other input fields. The UI 600-b may also include a selected business unit information field 630, which may indicate a partition (e.g., data space) that the business unit in the business unit indication field 625 is configured to utilize, one or more CMS workspaces associated with the business unit, or both. The UI 600-b may also include the information 640 which may indicate that a selected business unit (e.g., other than “none”) cannot be changed after the user selects a save button 655. In some cases, the UI 600-b may include a cancel button 645 to return to the UI 600-a, a save and new button 650 to instantiate the object according to the input in the UI 600-b and open a new instance of the UI 600-b, and the save button 655 to instantiate the object according to the input in the UI 600-b (e.g., and return to the UI 600-a).

After creating an object (e.g., a parent object) using the UI 600-b, the object may be added to the objects indicated in the UI 600-a. In some cases, the user may select an object from the UI 600-a and the cloud client may display one or more UIs associated with the object. For example, the cloud client may display the UI 600-c. In some cases, each UI associated with the object may include a business unit indication field 660-a, which may not be editable, and may indicate a business unit to which the object belongs. Additionally, the UI 600-c may include one or more inputs to create an object (e.g., a child object) within the object (e.g., a parent object). For example, one or more buttons 665 may allow a user to create a child object within the parent object, or one or more other fields (e.g., drop down menus, text input fields, numerical input fields) may allow a user to create a child object within the parent object from the UI 600-c.

In response to user input received in the UI 600-c (e.g., selecting a button 665), the cloud client may display the UI 600-d for the user to configure the child object. In some cases, the UI 600-d may include a business unit indication field 660-b, which may indicate that the child object is associated with the business unit of the parent object. That is, the business unit associated with the child object cannot be changed from the business unit associated with the parent object. Additionally, the UI 600-d may include other fields 635-b for configuring the child object. For example, the other fields 635-b may include one or more types of fields included in the other fields 635-a, such as a name field and one or more parameter fields associated with the child object. Similar to the UI 600-b, the UI 600-d may include a cancel button 645 to return to the UI 600-c, a save and new button 650 to instantiate the child object and display a new instance of the UI 600-d, and a save button 655 to instantiate the child object (e.g., and return to the UI 600-c).

In some cases, creating objects within business units using the UIs 600 may provide one or more technical advantages to a user device, cloud client, or data storage system. For example, objects created within business units may be configured to utilize a partition associated with the business unit. As the partition may include data associated with a set of user entities that is more specifically associated with the business unit and thus the object, the object utilizing the partition may effectuate more accurate and specific electronic communications, which may reduce resources wasted due to unwanted or incompatible electronic communications. Additionally, or alternatively, other communication management applications may not include UIs to create and manage objects within business units, which may not be a trivial task in a multi-user cloud based system. Thus, the UIs 600 may be improved user interfaces for user devices that allow the user to create and manage objects within a communication management application more efficiently.

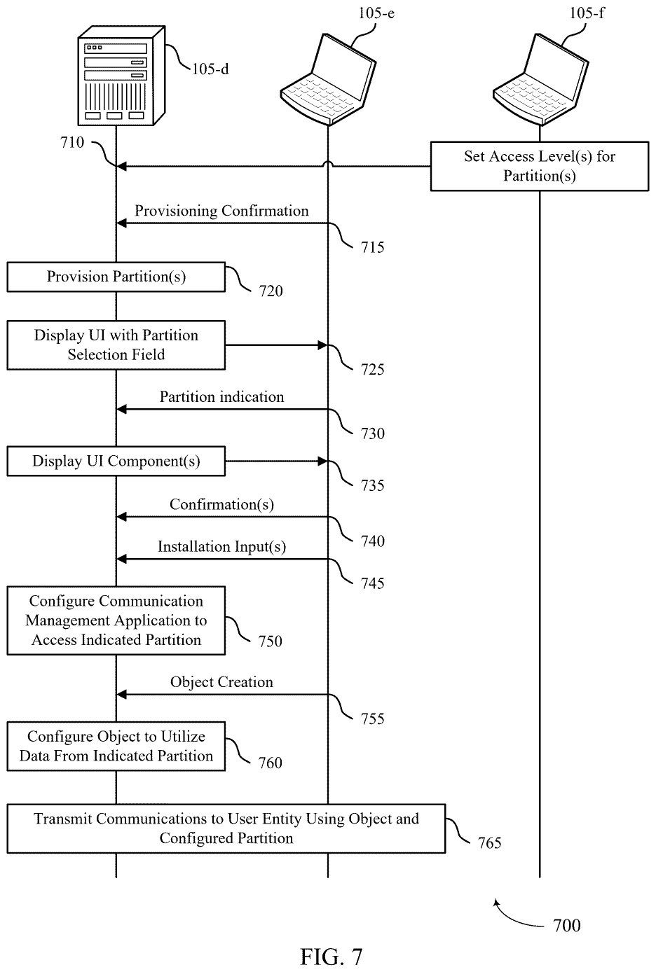

FIG. 7 shows an example of a process flow 700 that supports cloud data partitioning for a communication platform in accordance with aspects of the present disclosure. In some cases, aspects of the process flow 700 may implement or be implemented by aspects of FIGS. 1-6. For example, the process flow 700 may include a cloud client 105-d (e.g., a server, a data storage system), a cloud client 105-e, and a cloud client 105-f, which may be examples of cloud clients 105 as described herein with respect to FIGS. 1 and 2. For example, the cloud client 105-d may be a server configured to access or support a cloud data storage system (e.g., described herein with respect to FIG. 2). Additionally, or alternatively, the cloud client 105-e may include a first user device that a first user (e.g., a marketer, and employee) may use to access a first org (e.g., a first instance of the communication management application), and the cloud client 105-f may include a second user device (e.g., which may be the same as the first user device) that a second user (e.g., an administrative user, an owner, a manager) may use to access the first org or a second org related to the first org. For example, in some cases, the first org may be a companion org and the second org may be a home org, or vice versa, as described here with respect to FIGS. 4A-4C. In some aspects, the process flow 700 may illustrate techniques for the cloud clients 105-d, 105-e, and 105-f to configure the first org with a data space (e.g., a partition of a data storage system) as described with respect to FIGS. 3A-4C.

In the following description of process flow 700, the operations may be performed in a different order than the order shown, or other operations may be added or removed from the process flow 700. For example, some operations (e.g., one or more operations described with respect to FIGS. 2-6D) may be left out of process flow 700, may be performed in different orders or at different times, or other operations may be added to process flow 700. Although the cloud clients 105-d, 105-e, and 105-f are shown performing the operations of process flow 700, some aspects of some operations may also be performed by one or more other devices. Additionally, or alternatively, some operations performed by the cloud clients 105-d, 105-e, or 105-f may be performed at least in part by another of the cloud clients 105-d, 105-e, and 105-f.

At 710, the cloud client 105-d may receive, from the cloud client 105-f (e.g., from the second user associated with the second org), user input to provision (e.g., share, allocate) one or more partitions (e.g., data spaces) of a cloud data storage system to the first org (e.g., accessed by the first user of the cloud client 105-e). For example, the cloud client 105-f may display a UI (e.g., the UI 400-b) and the second user may provide user input to select one or more partitions to provision to the first org accessed by the cloud client 105-e. Additionally, or alternatively, provisioning the one or more partitions may include setting one or more access levels associated with each partition. For example, the first org may be one of multiple companion orgs to the second org, and the user of the cloud client 105-f may select an access level of each org (e.g., including the first org) for each partition. In some cases, if the access level of the first org is above a threshold access level for a partition, the partition may be provisioned to the first org.

In some cases, the one or more partitions of the cloud data storage system may include a default partition associated with instantiation of the first org and a non-default partition that is provisioned after the instantiation of the first org. For example, when the first org is instantiated, the cloud client 105-d may allocate a default data space (e.g., default partition) in the cloud data storage system for the first org to use to store and access data. However, until a partition is selected as the data space for the first org, the first org may not utilize the default data space. Additionally, or alternatively, the first org may begin storing data in the default data space, and may move the data from the default data space to a different partition if the different partition is selected as the data space for the first org at a later time.

At 715, the cloud client 105-d may receive, from the cloud client 105-e (e.g., from the first user of the first org), user input that indicates a confirmation associated with provisioning the one or more partitions. For example, the user input received at 710 may indicate an org ID associated with the first org as the recipient of the provisioned one or more partitions. The cloud client may notify the cloud client 105-e (e.g., the first user of the first org) of the provisioning of the one or more partitions to the first org based on the indicated org ID. The first user of the first org may accept the provisioning of the one or more partitions or may reject the provisioning of the one or more partitions, as described herein with respect to FIG. 4C.

At 720, based on the first user of the first org accepting the one or more partitions, the cloud client 105-d may provision the one or more partitions of the cloud data storage system to the first org (e.g., to the user of the first org). In some cases, the one or more partitions may be provisioned to the first org automatically based on the access level of the first org (e.g., or of the first user) with respect to each partition of the one or more partitions (e.g., without the first user accepting the provisioning). Additionally, or alternatively, the cloud client 105-d may wait for acceptance from the user to provision one or more first partitions to the first org from the second org, but may automatically provision later partitions to the first org from the second org based on the acceptance.

At 725, the cloud client 105-d may cause display of a UI (e.g., the UI 300-a) associated with the first org, where the UI may include a partition selection field for indicating a partition of one or more partitions of the cloud data storage system that are accessible to the first org (e.g., via the first org). For example, the cloud client 105-d (e.g., a server) may transmit an indication to display the UI to the cloud client 105-e, and the cloud client 105-e may display the UI on a screen or other display module of the first user device. In some cases, the partition selection field may include a text input field, a drop-down menu, a selection of a partition from a list of partitions, or any combination thereof (e.g., as described herein with respect to FIG. 3A). For example, the UI may display (e.g., in the dropdown menu, in the UI) the one or more partitions provisioned to (e.g., accessible to) the first org, which may include the default data space and one or more other partitions.

At 730, the cloud client 105-d may receive user input in the partition selection field of the UI displayed at 725, where the user input may indicate a partition to assign to the first org. In some cases, the indicated partition may be a non-default partition. For example, the indicated partition may be a partition of the one or more partitions provisioned after the instantiation of the first org (e.g., at 710 and 720).

At 735, in some cases, the cloud client 105-d may cause display, in response to receiving the indication of the partition to assign to the first org, of one or more UI components (e.g., UI 300-b, UI 300-c) that indicate one or more operations associated with configuring the first org to utilize the partition indicated at 730. For example, the one or more UI components may include a UI component including one or more warnings associated with the permanent nature of configuring the first org to utilize the indicated partition. Additionally, or alternatively, the one or more UI components may display a list of tasks to be completed (e.g., data kits to be downloaded to the cloud client 105-e) to configure the first org to utilize the indicated partition, which may be performed automatically or manually.

At 740, the cloud client 105-d may receive a confirmation from the cloud client 105-e (e.g., from the first user) via the displayed UI components. For example, if the one or more UI components include the one or more warnings, the confirmation may be in response to the one or more warnings. At 745, the cloud client 105-d may receive one or more user inputs from the cloud client 105-e (e.g., from the first user of the first org) to initiate installation of one or more data kits associated with the partition. For example, the one or more user inputs may be received via the list of tasks to complete (e.g., if the list of tasks are completed manually).

At 750, the cloud client 105-d (e.g., the server associated with the cloud data storage system) may configure the first org to access (e.g., utilize, store data in) the partition indicated at 730. In some cases, the installation inputs received at 745 may be part of configuring the first org to access the partition. In some cases, configuring the first org to access the indicated partition may include installing one or more data kits to the cloud client 105-e associated with the indicated partition, setting one or more variables within the first org to point to or indicate the indicated partition, storing initial data (e.g., identification data, authentication data, metadata) associated with the first org in the indicated partition, or any combination thereof.

At 755, the cloud client 105-e may create an object within the first org, where data and values of one or more parameters associated with the object may be stored at the cloud data storage system (e.g., the cloud client 105-d) within the partition assigned to the first org. In some cases, the object may include a campaign, a communication flow, content for the communication flow, a step in or logic for the communication flow, a segment of user entities associated with the first org, or any combination thereof. For example, the first user of the first org may use one or more UIs associated with the first org to input one or more parameter values or give other input to create the object.

At 760, the cloud client 105-d may configure the object within the first org to utilize data from the partition assigned to the first org (e.g., different from the default data space) based on configuring the first org to utilize the partition. For example, data used to create or implement the object may come from the partition. In one example, if the object is a segment, the segment may include one or more user entities based on data associated with the user entities that is stored in the partition (e.g., and not the default data space). As another example, if the object is an email including data about an intended recipient, the data may come from the partition assigned to the first org. In this way, the object may be created and implemented specifically for user entities associated with the first org, which may reduce unwanted or unusable electronic communication, and thus reduce wasted communication resources, computational resource, and power resources at a user device (e.g., the cloud client 105-e), the cloud data storage system (e.g., cloud client 105-d), or both.

At 765, one or more of the cloud clients 105-d and 105-e may transmit, based on the object, one or more electronic communications to one or more user entities in accordance with data stored in the partition based on configuring the first org to access the partition indicated by the first user at 730. For example, the electronic communications may include text message(s), email(s), voice message(s), phone call(s), video call(s), other electronic communication(s), or any combination thereof. The electronic communication may be sent to user entities whose information is stored in the partitions assigned to the first org, and may not be sent to user entities whose information is stored in the default data space or another partition. Additionally, the information in the electronic communication (e.g., text, images, sound recordings) may be based on data stored in the partition assigned to the first org. Such exclusionary techniques for determining recipients of the electronic communications and determining information to include in the electronic communications is enabled by selecting the partition (e.g., a non-default data space) and configuring the org to access the partition, and may reduce wasted electronic communication resources as well as power and computational resources at the cloud clients 105.

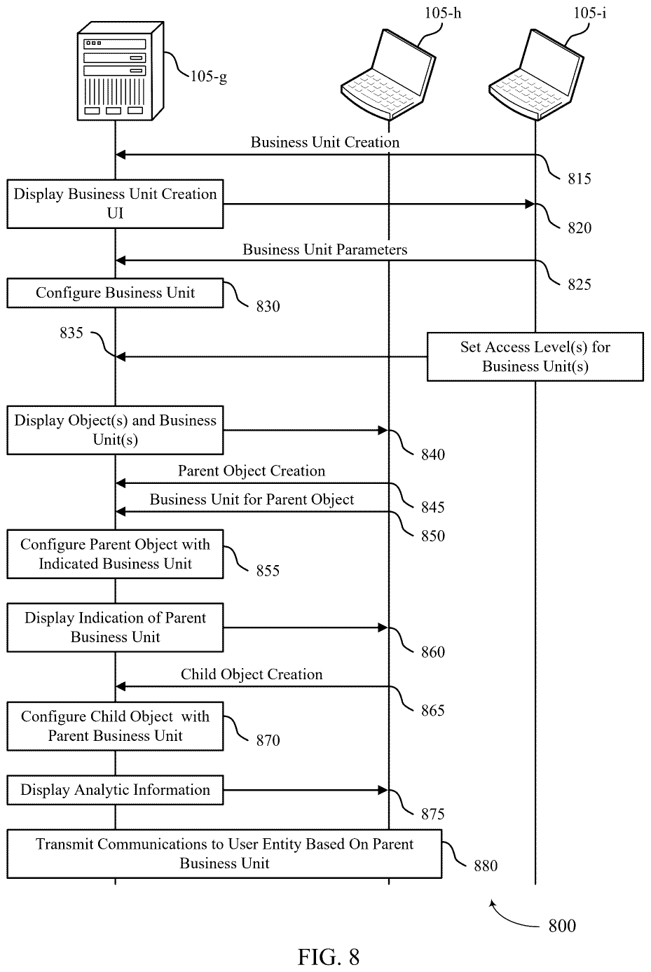

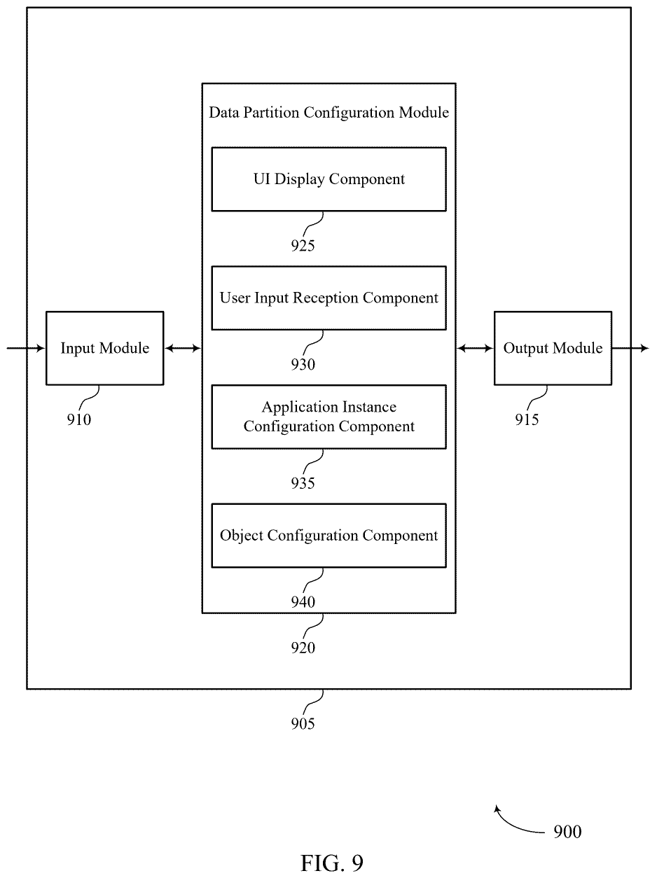

FIG. 8 shows an example of a process flow 800 that supports cloud data partitioning for a communication platform in accordance with aspects of the present disclosure. In some cases, aspects of the process flow 800 may implement or be implemented by aspects of FIGS. 1-7. For example, the process flow 800 may include a cloud client 105-g (e.g., a server), a cloud client 105-h, and a cloud client 105-i, which may be examples of cloud clients 105 as described herein with respect to FIGS. 1, 2, and 7. For example, the cloud client 105-g may be a server configured to access or support a cloud data storage system (e.g., described herein with respect to FIG. 2). Additionally, or alternatively, the cloud client 105-h may include a first user device that a first user (e.g., a marketer, and employee) may use to access an org (e.g., an instance of the communication management application), and the cloud client 105-f may include a second user device (e.g., which may be the same as the first user device) that a second user (e.g., an administrative user, an owner, a manager) may use to access the org. In some aspects, the process flow 800 may illustrate techniques for the cloud clients 105-d, 105-e, and 105-f to configure one or more business units within the org and create objects within the one or more business units, as described with respect to FIGS. 5A-6D.

In the following description of process flow 800, the operations may be performed in a different order than the order shown, or other operations may be added or removed from the process flow 800. For example, some operations (e.g., one or more operations described with respect to FIGS. 2-6D) may be left out of process flow 800, may be performed in different orders or at different times, or other operations may be added to process flow 800. Although the cloud clients 105-g, 105-h, and 105-i are shown performing the operations of process flow 800, some aspects of some operations may also be performed by one or more other devices. Additionally, or alternatively, some operations performed by the cloud clients 105-g, 105-h, or 105-i may be performed at least in part by another of the cloud clients 105-g, 105-h, and 105-i.

At 815, the cloud client 105-g may receive user input from the cloud client 105-i (e.g., or from the cloud client 105-h) to create a business unit within an org (e.g., within an instance of the communication management application). A business unit may correspond to a respective partition (e.g., data space) of a cloud data storage system that is accessible to the org, and each respective partition may be configured to store data associated with a respective set of user entities associated with the corresponding business unit. For example, the business unit may be configured to access (e.g., utilize) a corresponding partition in a similar manner that an org may be configured to access non-default partitions (e.g., as described herein with respect to FIGS. 3A-4C and 7). In some cases, each business unit may further correspond to one or more content management resources (e.g., one or more CMSs) for managing content communicated with the respective set of user entities associated with the business unit. For example, a content management resource may also be a partition of the cloud data storage system configured to store content (e.g., images, text, logos, sounds clips, video clips, color palettes, other graphics) separate from data associated with user entities (e.g., stored in the data space associated with the business unit).

At 820, in response to receiving the user input to create a business unit, the cloud client 105-g may cause display of a UI (e.g., the UI 500-b, a business unit creation UI) at the cloud client 105-i, where the UI may include a name input field, a partition selection field, a content management resource selection field, one or more other fields for inputting business unit parameters, or any combination thereof (e.g., as described herein with respect to FIG. 5B). To cause display of the business unit creation UI, the cloud client 105-g may transmit one or more signals to the cloud client 105-i that indicate the business unit creation UI, and the cloud client 105-i may display the business unit creation UI on a screen or other display component of the cloud client 105-i.

At 825, the cloud client 105-g may receive one or more business unit parameters from the cloud client 105-i via the business unit creation UI. For example, the cloud client 105-g may receive user input in the name input field of the business unit creation UI that indicates a name of the business unit, user input in the partition selection field that indicates a first partition (e.g., data space) to assign to the business unit from one or more partitions associated with the org (e.g., accessible to the org, based on provisioned partitions and access levels set as described herein with respect to FIG. 7 at 710), user input in the content management resource selection field that indicates one or more content management resources to assign to the business unit, or any combination thereof. In some cases, access levels of the org for content management resources may be set and content management resources may be provisioned to the org by an administrative user in a similar manner as the partitions (e.g., as described herein with respect to FIG. 7 at 710 through 720).

Additionally, or alternatively, the business unit parameters received via the business unit creation UE may include user input configuring one or more communication settings associated with the business unit. For example, the communication settings may include reply addresses, availability, automatic replies, or other communication settings. In some cases, the communication settings set for the business unit may be different than one or more second communication settings associated with another business unit.

At 830, the cloud client 105-g may configure the business unit based on the received business unit parameters, including the indicated partition and content management resources. For example, the cloud client 105-g may configure the indicated partition to store data associated with a set of user entities that correspond to the business unit. As an example, if the business unit is directed toward a brand or product of a business, the set of user entities that correspond to the business unit may include user entities that have interacted with the brand or product (e.g., purchased the product or a product of the brand, browsed the website for the product or brand, signed up for newsletters for the product or brand). Thus, the data space for the business unit may store the data or user entities that are directly related to the business unit.

At 835, the cloud client 105-g may receive, from the cloud client 105-i (e.g., from an administrative user associated with the org), user input that indicates an access level of the cloud client 105-h (e.g., of another user associated with the org) with respect to each business unit of a set of business units (e.g., one or more business units, multiple business units) associated with the org (e.g., including the business unit created at 815 through 830). Additionally, or alternatively, if the cloud client 105-i is associated with a second org (e.g., a home org, a second instance of the communication management application), cloud client 105-g may receive an indication of an access level of each companion org (e.g., including the org associated with the cloud client 105-h) for each of the plurality of business units associated with the second org. For example, the plurality of business units accessible by the org (e.g., a companion org) may exclude one or more business units associated with the second org (e.g., a home org, a related org) based on the access level of the user or the org with respect to each business unit of the set of business units.

At 840, the cloud client 105-g (e.g., and the cloud client 105-h) may cause display, in a UI (e.g., the UI 600-a), of one or more indications (e.g., names) of one or more objects and a business unit corresponding to each of the one or more objects. Additionally, or alternatively, the UI may include an indication of one or more object that are not associated with a business unit (e.g., not assigned to a business unit, not created within a business unit), where the one or more objects may utilize data from a partition of the cloud data storage system that is associated with the org (e.g., but not associated with any business unit). That is, an org may include one or more objects that are not within any business unit (e.g., do not utilize a data space associated with any business unit of the org).

At 845, the cloud client 105-g may receive user input from the cloud client 105-h to create an object (e.g., a parent object) within the org. For example, the cloud client 105-g may receive the user input via the UI displayed at 840 (e.g., the UI 600-a) at the cloud client 105-h. In some cases, such user input may include clicking or tapping on a button labeled “new” or “create” within the UI. Additionally, the cloud client 105-h may provide one or more parameters for creating the object. Such parameters may include a name, a creator, notes to other users, content to include in the object, logic (e.g., for communication flows or campaigns), text to be included in communications, or other parameters.

At 850, the cloud client 105-g may receive user input that indicates a business unit of the set of business units associated with the org (e.g., accessible based on access levels of the org) to assign to the object created at 845. As described herein, the indicated business unit may correspond to and utilize a partition (e.g., data space) of the cloud data storage system. As an example, if the object created at 845 is a communication flow for communicating with user entities that live in North America and speak Spanish, the user input may indicate a “North American Spanish Speaking” business unit, which may correspond to and utilize a partition of the cloud data storage system that stores data associated with (e.g., exclusively associated with) user entities that live in North America and speak Spanish. Additionally, or alternatively, the object may be a new campaign to market products within a brand of a business that owns the org. Accordingly, the user input may indicate a business unit associated with the brand, and the partition associated with the business unit may store data associated with user entities that interact with or have shown interest in the brand. Additionally, content management resources associated with the business unit may store content (e.g., graphics, logos, colors, sounds bites, videos) associated with the brand. Accordingly, any use of the object to communicate with the user entities may have increased specificity and thus reduced communication resource, computational resource, or power resource waste.

At 855, the cloud client 105-g may configure the object (e.g., the parent object), based at least in part on the business unit indicated at 850, to utilize data from the partition that corresponds to the indicated business unit. That is, the cloud client 105-g may set one or more parameters or data paths associated with the object such that the object references data stored in the partition of the cloud data storage system associated with the business unit, and does not reference data stored in other partitions. After configuring the object to utilize data from the partition of the corresponding business unit, the cloud client 105-g may cause the display of one or more other UIs associated with the object to further define, edit, and utilize the object for electronic communications with user entities associated with the business unit.

In some cases, operations performed at 845 through 855 may be repeated for other objects created within other business units. For example, the cloud client 105-g may receive user input to create a second object within the org, receive user input that indicates a second business unit of the set of business units to assign to the second object, and configure the second object to utilize data from a second partition within the cloud data storage system configured to store data associated with user entities corresponding to the second business unit. For example, if the business units are different for the object created at 845 and the second object, the objects may utilize different partitions and thus access different data based on being assigned to different business units.

At 860, the cloud client 105-g may display an indication of the first business unit in one or more UIs (e.g., UI 600-c, UI 600-d, other UIs) of the communication management application for configuring the object or any child object of the object based on the object being configured to utilize data from the partition associated with the business unit. Additionally, or alternatively, in response to configuring the object to utilize the partition associated with the business unit, the cloud client 105-g may update the set of objects displayed at 840 (e.g., in the UI 600-a) to include the object and the corresponding business unit.

At 865, the cloud client 105-g may receive user input (e.g., via a UI like the UI 600-c) from the cloud client 105-h (e.g., from a user of the cloud client 105-h) to create another object within the org that is associated with the object created at 845. For example, the other object may be a child object of the object, which may be referred to as the parent object. As an example, the user input may include clicking or tapping a button in a UI associated with the parent object or otherwise indicating the intent to create a child object within the parent object. For example, if the parent object is a campaign, the child object may be a communication flow, a piece of content, or a segment. Additionally, the cloud client 105-h may indicate one or more parameters for the child object, which may include a name, a creator, or other information associated with the child object (e.g., as described herein at 845).

At 870, the cloud client 105-g may configure the child object, based on the user input to create the child object within the parent object, to utilize the data from the partition that corresponds to the business unit associated with the parent object. That is, the cloud client 105-h (e.g., and thus a user of the cloud client 105-h) may not input an explicit indication of a business unit to assign to the child object other than creating the child object within the parent object. Instead, the cloud client 105-g may automatically configure the child object to utilize data from the partition associated with the business unit of the parent object based on being created within the parent object. Such automatic configuring to use the more specific data of the business unit associate with the parent object (e.g., instead of a default data space or another partition) may increase specificity in wireless communications conducted using the child object, which may reduce wasted communication, power, and computational resources at the cloud clients 105.

At 875, the cloud client 105-g may cause display, in a UI at the cloud client 105-h, analytic information associated with multiple business units associated with (e.g., accessible to) an org. For example, the UI may be associated with a second business unit corresponding to a second partition of the cloud data storage system. In some cases, the second partition may be configured to store (e.g., receive) data associated with multiple sets of user entities associated with the multiple business units, which may allow the second business unit to display analytic information associated with the multiple business units. Such analytic information may show profitability or other measures of success of each business unit, segments of user entities across business units, or other information. Additionally, a cloud client 105 may create one or more objects in the second business unit that utilize the second partition (e.g., effectively utilizing the partitions of each of the multiple business units). Such a business unit may allow for an improved user interface on a user device to organize communication efforts (e.g., marketing communications, sales communications, commerce communications, service communications) and reduce resource usage across business units.

At 880, one or more of the cloud client 105-g and the cloud client 105-h may transmit one or more electronic communications to one or more user entities based on the parent object, the child object, or both. For example, the electronic communications may be transmitted in accordance with the data stored in the partition associated with the business unit (e.g., and not other partitions) based on configuring the parent object to utilize the data stored at the partition that corresponds to the business unit. In some cases, such techniques may increase specificity and relevance of electronic communications transmitted to user entities. Increased specificity and relevance may decrease unwanted, irrelevant, or incompatible electronic communications, which may reduce wasted communication resources, wasted power resources, and wasted computational resources at the cloud clients 105.

FIG. 9 shows a block diagram 900 of a device 905 that supports cloud data partitioning for a communication platform in accordance with aspects of the present disclosure. The device 905 may include an input module 910, an output module 915, and a data partition configuration module 920. The device 905, or one or more components of the device 905 (e.g., the input module 910, the output module 915, the data partition configuration module 920), may include at least one processor, which may be coupled with at least one memory, to support the described techniques. Each of these components may be in communication with one another (e.g., via one or more buses).

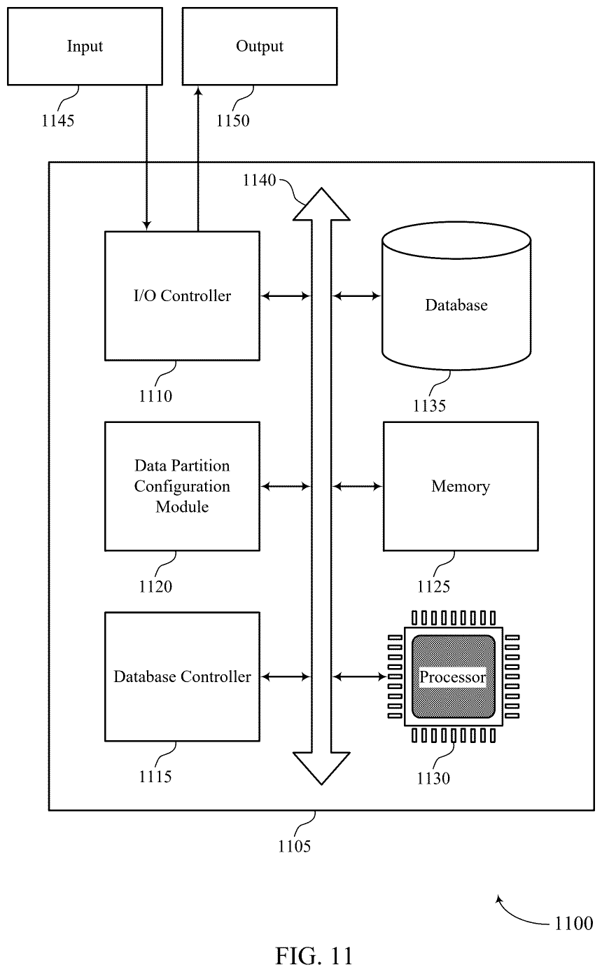

The input module 910 may manage input signals for the device 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the device 905 for processing. For example, the input module 910 may transmit input signals to the data partition configuration module 920 to support cloud data partitioning for a communication platform. In some cases, the input module 910 may be a component of an input/output (I/O) controller 1110 as described with reference to FIG. 11.

The output module 915 may manage output signals for the device 905. For example, the output module 915 may receive signals from other components of the device 905, such as the data partition configuration module 920, and may transmit these signals to other components or devices. In some examples, the output module 915 may transmit output signals for display in a user interface, for storage in a database or data store, for further processing at a server or server cluster, or for any other processes at any number of devices or systems. In some cases, the output module 915 may be a component of an I/O controller 1110 as described with reference to FIG. 11.

For example, the data partition configuration module 920 may include a UI display component 925, a user input reception component 930, an application instance configuration component 935, an object configuration component 940, or any combination thereof. In some examples, the data partition configuration module 920, or various components thereof, may be configured to perform various operations (e.g., receiving, monitoring, transmitting) using or otherwise in cooperation with the input module 910, the output module 915, or both. For example, the data partition configuration module 920 may receive information from the input module 910, send information to the output module 915, or be integrated in combination with the input module 910, the output module 915, or both to receive information, transmit information, or perform various other operations as described herein.

The data partition configuration module 920 may support data processing in accordance with examples as disclosed herein. The UI display component 925 may be configured to support causing display of a user interface associated with an instance of a communication management application, where the user interface includes a partition selection field for indicating a partition of one or more partitions of a cloud data storage system that are accessible via the instance of the communication management application. The user input reception component 930 may be configured to support receiving first user input in the partition selection field indicating the partition to assign to the instance of the communication management application. The application instance configuration component 935 may be configured to support configuring, in response to receiving the first user input, the instance of the communication management application to access the partition indicated by the first user input. The object configuration component 940 may be configured to support configuring an object within the instance of the communication management application to utilize data from the partition based on configuring the instance of the communication management application to utilize the partition.

Additionally, or alternatively, the data partition configuration module 920 may support data processing in accordance with examples as disclosed herein. The user input reception component 930 may be configured to support receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units. The user input reception component 930 may be configured to support receiving a second user input that indicates a first business unit of the set of multiple business units to assign to the first object, where the first business unit corresponds to a first partition of the cloud data storage system. The object configuration component 940 may be configured to support configuring the first object, based on the second user input, to utilize data from the first partition that corresponds to the first business unit. The user input reception component 930 may be configured to support receiving third user input to create a second object within the instance of the communication management application and associated with the first object. The object configuration component 940 may be configured to support configuring the second object, based on the third user input to create the second object within the first object, to utilize the data from the first partition that corresponds to the first business unit.

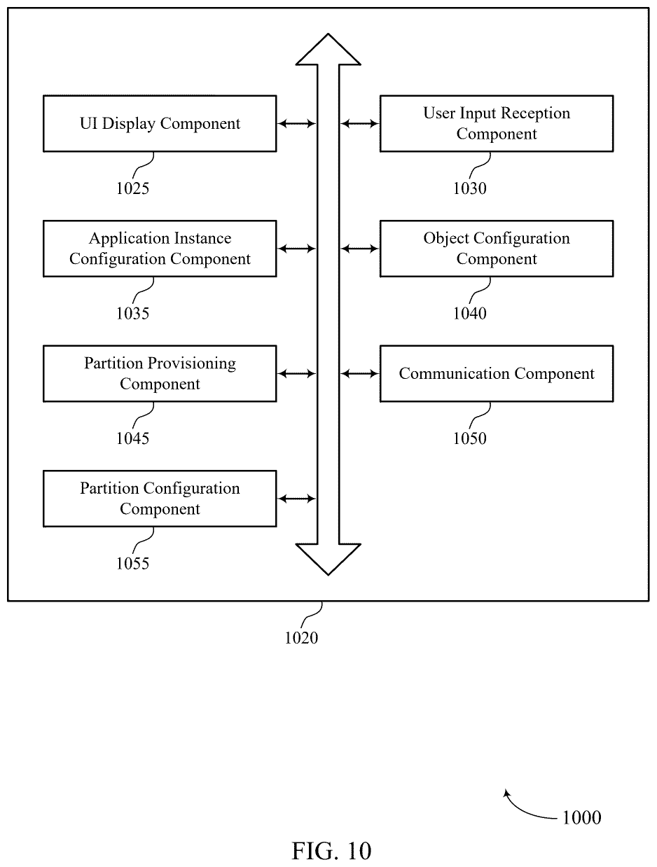

FIG. 10 shows a block diagram 1000 of a data partition configuration module 1020 that supports cloud data partitioning for a communication platform in accordance with aspects of the present disclosure. The data partition configuration module 1020 may be an example of aspects of a data partition configuration module or a data partition configuration module 920, or both, as described herein. The data partition configuration module 1020, or various components thereof, may be an example of means for performing (e.g., to cause the data partition configuration module 1020 to perform) various aspects of cloud data partitioning for a communication platform as described herein. For example, the data partition configuration module 1020 may include a UI display component 1025, a user input reception component 1030, an application instance configuration component 1035, an object configuration component 1040, a partition provisioning component 1045, a communication component 1050, a partition configuration component 1055, or any combination thereof. Each of these components, or components of subcomponents thereof (e.g., one or more processors, one or more memories), may communicate, directly or indirectly, with one another (e.g., via one or more buses).

The data partition configuration module 1020 may support data processing in accordance with examples as disclosed herein. The UI display component 1025 may be configured to support causing display of a user interface associated with an instance of a communication management application, where the user interface includes a partition selection field for indicating a partition of one or more partitions of a cloud data storage system that are accessible via the instance of the communication management application. The user input reception component 1030 may be configured to support receiving first user input in the partition selection field indicating the partition to assign to the instance of the communication management application. The application instance configuration component 1035 may be configured to support configuring, in response to receiving the first user input, the instance of the communication management application to access the partition indicated by the first user input. The object configuration component 1040 may be configured to support configuring an object within the instance of the communication management application to utilize data from the partition based on configuring the instance of the communication management application to utilize the partition.

In some examples, the partition provisioning component 1045 may be configured to support provisioning the one or more partitions of the cloud data storage system to a user of the instance of the communication management application based on an access level of the user with respect to each partition of the one or more partitions, where the first user input is based on provisioning the one or more partitions to the user.

In some examples, the user input reception component 1030 may be configured to support receiving, from a first user of a second instance of the communication management application, fourth user input to provision the partition to the instance of the communication management application. In some examples, the user input reception component 1030 may be configured to support receiving, from a second user of the instance of the communication management application and based on the fourth user input, fifth user input that indicates a confirmation associated with provisioning the partition. In some examples, the partition provisioning component 1045 may be configured to support provisioning the partition to the instance of the communication management application based on the confirmation.

In some examples, the one or more partitions of the cloud data storage system include a default partition associated with instantiation of the instance of the communication management application and a non-default partition that is provisioned after the instantiation of the instance of the communication management application.

In some examples, the partition to assign to the instance of the communication management application includes the non-default partition that is provisioned after the instantiation of the instance of the communication management application.

In some examples, the UI display component 1025 may be configured to support causing display, in response to receiving the first user input, of one or more user interface components that indicate one or more operations associated with configuring the instance of the communication management application to utilize the partition indicated by the first user input.

In some examples, to support configuring the instance of the communication management application to access the partition, the user input reception component 1030 may be configured to support receiving one or more fourth user inputs to initiate installation of one or more data kits associated with the partition.

In some examples, the communication component 1050 may be configured to support transmitting, based on the object, one or more electronic communications to a user entity in accordance with data stored in the partition based on configuring the instance of the communication management application to access the partition indicated by the first user input.

Additionally, or alternatively, the data partition configuration module 1020 may support data processing in accordance with examples as disclosed herein. In some examples, the user input reception component 1030 may be configured to support receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units. In some examples, the user input reception component 1030 may be configured to support receiving a second user input that indicates a first business unit of the set of multiple business units to assign to the first object, where the first business unit corresponds to a first partition of the cloud data storage system. In some examples, the object configuration component 1040 may be configured to support configuring the first object, based on the second user input, to utilize data from the first partition that corresponds to the first business unit. In some examples, the user input reception component 1030 may be configured to support receiving third user input to create a second object within the instance of the communication management application and associated with the first object. In some examples, the object configuration component 1040 may be configured to support configuring the second object, based on the third user input to create the second object within the first object, to utilize the data from the first partition that corresponds to the first business unit.

In some examples, each business unit further corresponds to one or more content management resources for managing content communicated with the respective set of user entities associated with the business unit.

In some examples, the UI display component 1025 may be configured to support causing display, in a user interface, of one or more indications of one or more objects and a business unit corresponding to each of the one or more objects, the one or more objects including the first object that corresponds to the first business unit, where the first user input is received in the user interface.

In some examples, the UI display component 1025 may be configured to support causing display, in the user interface, of an indication of a third object that is not associated with a business unit, where the third object utilizes data from a third partition of the cloud data storage system associated with the instance of the communication management application.

In some examples, the user input reception component 1030 may be configured to support receiving fourth user input to create a third object within the instance of the communication management application. In some examples, the user input reception component 1030 may be configured to support receiving the fifth user input that indicates a second business unit of the set of multiple business units to assign to the third object. In some examples, the object configuration component 1040 may be configured to support configuring, in response to receiving the second user input, the second object to utilize data from a second partition within the cloud data storage system, the second partition configured to store second data associated with a second set of user entities corresponding to the second business unit.

In some examples, the set of multiple business units associated with the instance of the communication management application is based on an access level of a user of the instance of the communication management application with respect to each business unit of the set of multiple business units.

In some examples, the user input reception component 1030 may be configured to support receiving, from an administrative user, fourth user input that indicates the access level of the user with respect to each business unit of the set of multiple business units.

In some examples, the set of multiple business units excludes one or more business units associated with a related instance of the communication management application based on the access level of the user with respect to the one or more business units.

In some examples, the UI display component 1025 may be configured to support displaying an indication of the first business unit in one or more user interfaces of the communication management application for configuring the first object or the second object based on the first object being configured to utilize data from the first partition associated with the first business unit.

In some examples, the user input reception component 1030 may be configured to support receiving fourth user input to create the first business unit. In some examples, the UI display component 1025 may be configured to support causing display, in response to receiving the fourth user input, of a user interface that includes a name input field, a partition selection field, and a content management resource selection field. In some examples, the user input reception component 1030 may be configured to support receiving fifth user input in the name input field that indicates a name of the first business unit. In some examples, the user input reception component 1030 may be configured to support receiving sixth user input in the partition selection field that indicates the first partition to assign to the first business unit from one or more partitions associated with the instance of the communication management application. In some examples, the user input reception component 1030 may be configured to support receiving seventh user input in the content management resource selection field that indicates one or more content management resources to assign to the first business unit. In some examples, the partition configuration component 1055 may be configured to support configuring the first partition to store the data associated with a set of user entities associated with the first business unit.

In some examples, the user input reception component 1030 may be configured to support receiving fourth user input configuring one or more first communication settings associated with the first business unit that are different from one or more second communication settings associated with a second business unit of the set of multiple business units.

In some examples, the UI display component 1025 may be configured to support causing display, in a user interface associated with a second business unit corresponding to a second partition of the cloud data storage system, analytic information associated with the first business unit and a third business unit of the set of multiple business units based on the second partition receiving first data associated with a first set of user entities associated with the first business unit and receiving second data associated with a second set of clients associated with the third business unit.

In some examples, the communication component 1050 may be configured to support transmitting one or more electronic communications to a user entity based on the first object, the second object, or both, in accordance with the data stored in the first partition based on configuring the first object to utilize the data stored at the first partition that corresponds to the first business unit.

FIG. 11 shows a diagram of a system 1100 including a device 1105 that supports cloud data partitioning for a communication platform in accordance with aspects of the present disclosure. The device 1105 may be an example of or include components of a device 905 as described herein. The device 1105 may include components for bi-directional data communications including components for transmitting and receiving communications, such as a data partition configuration module 1120, an I/O controller, such as an I/O controller 1110, a database controller 1115, at least one memory 1125, at least one processor 1130, and a database 1135. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

The database controller 1115 may manage data storage and processing in a database 1135. In some cases, a user may interact with the database controller 1115. In other cases, the database controller 1115 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause at least one processor 1130 to perform various functions described herein. In some cases, the memory 1125 may contain, among other things, a basic I/O system (BIOS) which may control basic hardware or software operation such as the interaction with peripheral components or devices. The memory 1125 may be an example of a single memory or multiple memories. For example, the device 1105 may include one or more memories 1125.

The processor 1130 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in at least one memory 1125 to perform various functions (e.g., functions or tasks supporting cloud data partitioning for a communication platform). The processor 1130 may be an example of a single processor or multiple processors. For example, the device 1105 may include one or more processors 1130.

The data partition configuration module 1120 may support data processing in accordance with examples as disclosed herein. For example, the data partition configuration module 1120 may be configured to support causing display of a user interface associated with an instance of a communication management application, where the user interface includes a partition selection field for indicating a partition of one or more partitions of a cloud data storage system that are accessible via the instance of the communication management application. The data partition configuration module 1120 may be configured to support receiving first user input in the partition selection field indicating the partition to assign to the instance of the communication management application. The data partition configuration module 1120 may be configured to support configuring, in response to receiving the first user input, the instance of the communication management application to access the partition indicated by the first user input. The data partition configuration module 1120 may be configured to support configuring an object within the instance of the communication management application to utilize data from the partition based on configuring the instance of the communication management application to utilize the partition.

Additionally, or alternatively, the data partition configuration module 1120 may support data processing in accordance with examples as disclosed herein. For example, the data partition configuration module 1120 may be configured to support receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units. The data partition configuration module 1120 may be configured to support receiving second user input that indicates a first business unit of the set of multiple business units to assign to the first object, where the first business unit corresponds to a first partition of the cloud data storage system. The data partition configuration module 1120 may be configured to support configuring the first object, based on the second user input, to utilize data from the first partition that corresponds to the first business unit. The data partition configuration module 1120 may be configured to support receiving third user input to create a second object within the instance of the communication management application and associated with the first object. The data partition configuration module 1120 may be configured to support configuring the second object, based on the third user input to create the second object within the first object, to utilize the data from the first partition that corresponds to the first business unit.

By including or configuring the data partition configuration module 1120 in accordance with examples as described herein, the device 1105 may support techniques for reduced power consumption, more efficient utilization of communication resources, and improved coordination between devices.

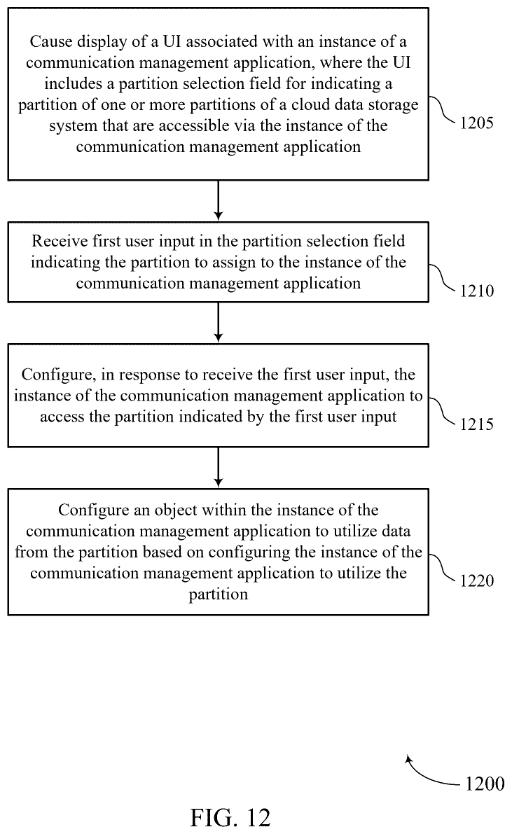

FIG. 12 shows a flowchart illustrating a method 1200 that supports cloud data partitioning for a communication platform in accordance with aspects of the present disclosure. The operations of the method 1200 may be implemented by a Server or its components as described herein. For example, the operations of the method 1200 may be performed by a Server as described with reference to FIGS. 1 through 11. In some examples, a Server may execute a set of instructions to control the functional elements of the Server to perform the described functions. Additionally, or alternatively, the Server may perform aspects of the described functions using special-purpose hardware.

At 1205, the method may include causing display of a user interface associated with an instance of a communication management application, where the user interface includes a partition selection field for indicating a partition of one or more partitions of a cloud data storage system that are accessible via the instance of the communication management application. The operations of 1205 may be performed in accordance with examples as disclosed herein. In some examples, aspects of the operations of 1205 may be performed by a UI display component 1025.

At 1210, the method may include receiving first user input in the partition selection field indicating the partition to assign to the instance of the communication management application. The operations of 1210 may be performed in accordance with examples as disclosed herein. In some examples, aspects of the operations of 1210 may be performed by a user input reception component 1030.

At 1215, the method may include configuring, in response to receiving the first user input, the instance of the communication management application to access the partition indicated by the first user input. The operations of 1215 may be performed in accordance with examples as disclosed herein. In some examples, aspects of the operations of 1215 may be performed by an application instance configuration component 1035.

At 1220, the method may include configuring an object within the instance of the communication management application to utilize data from the partition based on configuring the instance of the communication management application to utilize the partition. The operations of 1220 may be performed in accordance with examples as disclosed herein. In some examples, aspects of the operations of 1220 may be performed by an object configuration component 1040.

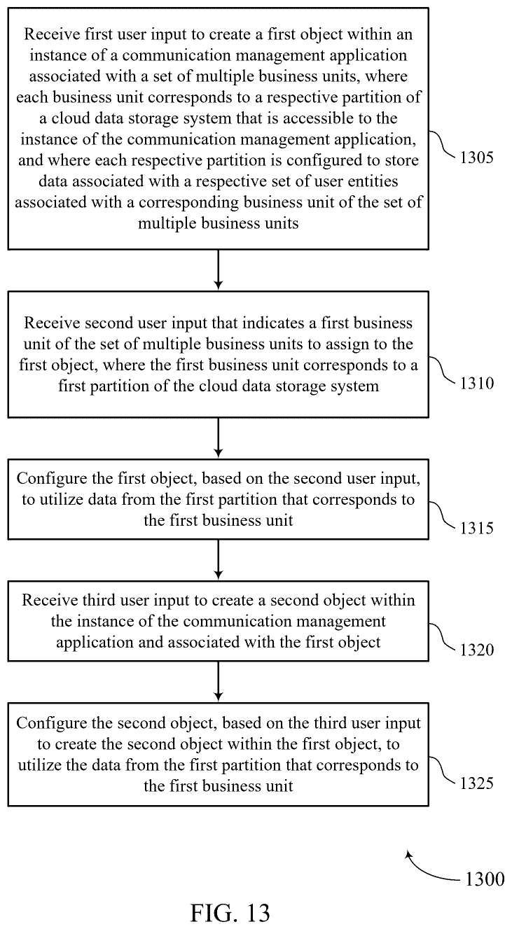

FIG. 13 shows a flowchart illustrating a method 1300 that supports cloud data partitioning for a communication platform in accordance with aspects of the present disclosure. The operations of the method 1300 may be implemented by a Server or its components as described herein. For example, the operations of the method 1300 may be performed by a Server as described with reference to FIGS. 1 through 11. In some examples, a Server may execute a set of instructions to control the functional elements of the Server to perform the described functions. Additionally, or alternatively, the Server may perform aspects of the described functions using special-purpose hardware.

At 1305, the method may include receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units. The operations of 1305 may be performed in accordance with examples as disclosed herein. In some examples, aspects of the operations of 1305 may be performed by a user input reception component 1030.

At 1310, the method may include receiving second user input that indicates a first business unit of the set of multiple business units to assign to the first object, where the first business unit corresponds to a first partition of the cloud data storage system. The operations of 1310 may be performed in accordance with examples as disclosed herein. In some examples, aspects of the operations of 1310 may be performed by a user input reception component 1030.

At 1315, the method may include configuring the first object, based on the second user input, to utilize data from the first partition that corresponds to the first business unit. The operations of 1315 may be performed in accordance with examples as disclosed herein. In some examples, aspects of the operations of 1315 may be performed by an object configuration component 1040.

At 1320, the method may include receiving third user input to create a second object within the instance of the communication management application and associated with the first object. The operations of 1320 may be performed in accordance with examples as disclosed herein. In some examples, aspects of the operations of 1320 may be performed by a user input reception component 1030.

At 1325, the method may include configuring the second object, based on the third user input to create the second object within the first object, to utilize the data from the first partition that corresponds to the first business unit. The operations of 1325 may be performed in accordance with examples as disclosed herein. In some examples, aspects of the operations of 1325 may be performed by an object configuration component 1040.

A method for data processing by an apparatus is described. The method may include causing display of a user interface associated with an instance of a communication management application, where the user interface includes a partition selection field for indicating a partition of one or more partitions of a cloud data storage system that are accessible via the instance of the communication management application, receiving first user input in the partition selection field indicating the partition to assign to the instance of the communication management application, configuring, in response to receiving the first user input, the instance of the communication management application to access the partition indicated by the first user input, and configuring an object within the instance of the communication management application to utilize data from the partition based on configuring the instance of the communication management application to utilize the partition.

An apparatus for data processing is described. The apparatus may include one or more memories storing processor executable code, and one or more processors coupled with the one or more memories. The one or more processors may individually or collectively be operable to execute the code to cause the apparatus to cause display of a user interface associated with an instance of a communication management application, where the user interface includes a partition selection field for indicating a partition of one or more partitions of a cloud data storage system that are accessible via the instance of the communication management application, receive first user input in the partition selection field indicating the partition to assign to the instance of the communication management application, configure, in response to receiving the first user input, the instance of the communication management application to access the partition indicated by the first user input, and configure an object within the instance of the communication management application to utilize data from the partition based on configuring the instance of the communication management application to utilize the partition.

Another apparatus for data processing is described. The apparatus may include means for causing display of a user interface associated with an instance of a communication management application, where the user interface includes a partition selection field for indicating a partition of one or more partitions of a cloud data storage system that are accessible via the instance of the communication management application, means for receiving first user input in the partition selection field indicating the partition to assign to the instance of the communication management application, means for configuring, in response to receiving the first user input, the instance of the communication management application to access the partition indicated by the first user input, and means for configuring an object within the instance of the communication management application to utilize data from the partition based on configuring the instance of the communication management application to utilize the partition.

A non-transitory computer-readable medium storing code for data processing is described. The code may include instructions executable by one or more processors to cause display of a user interface associated with an instance of a communication management application, where the user interface includes a partition selection field for indicating a partition of one or more partitions of a cloud data storage system that are accessible via the instance of the communication management application, receive first user input in the partition selection field indicating the partition to assign to the instance of the communication management application, configure, in response to receiving the first user input, the instance of the communication management application to access the partition indicated by the first user input, and configure an object within the instance of the communication management application to utilize data from the partition based on configuring the instance of the communication management application to utilize the partition.

Some examples of the method, apparatus, and non-transitory computer-readable medium described herein may further include operations, features, means, or instructions for provisioning the one or more partitions of the cloud data storage system to a user of the instance of the communication management application based on an access level of the user with respect to each partition of the one or more partitions, where the first user input may be based on provisioning the one or more partitions to the user.

Some examples of the method, apparatus, and non-transitory computer-readable medium described herein may further include operations, features, means, or instructions for receiving, from a first user of a second instance of the communication management application, fourth user input to provision the partition to the instance of the communication management application, receiving, from a second user of the instance of the communication management application and based on the fourth user input, fifth user input that indicates a confirmation associated with provisioning the partition, and provisioning the partition to the instance of the communication management application based on the confirmation.

In some examples of the method, apparatus, and non-transitory computer-readable medium described herein, the one or more partitions of the cloud data storage system include a default partition associated with instantiation of the instance of the communication management application and a non-default partition that may be provisioned after the instantiation of the instance of the communication management application.

In some examples of the method, apparatus, and non-transitory computer-readable medium described herein, the partition to assign to the instance of the communication management application includes the non-default partition that may be provisioned after the instantiation of the instance of the communication management application.

Some examples of the method, apparatus, and non-transitory computer-readable medium described herein may further include operations, features, means, or instructions for causing display, in response to receiving the first user input, of one or more user interface components that indicate one or more operations associated with configuring the instance of the communication management application to utilize the partition indicated by the first user input.

In some examples of the method, apparatus, and non-transitory computer-readable medium described herein, configuring the instance of the communication management application to access the partition may include operations, features, means, or instructions for receiving one or more fourth user inputs to initiate installation of one or more data kits associated with the partition.

Some examples of the method, apparatus, and non-transitory computer-readable medium described herein may further include operations, features, means, or instructions for transmitting, based on the object, one or more electronic communications to a user entity in accordance with data stored in the partition based on configuring the instance of the communication management application to access the partition indicated by the first user input.

A method for data processing by an apparatus is described. The method may include receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units, receiving second user input that indicates a first business unit of the set of multiple business units to assign to the first object, where the first business unit corresponds to a first partition of the cloud data storage system, configuring the first object, based on the second user input, to utilize data from the first partition that corresponds to the first business unit, receiving third user input to create a second object within the instance of the communication management application and associated with the first object, and configuring the second object, based on the third user input to create the second object within the first object, to utilize the data from the first partition that corresponds to the first business unit.

An apparatus for data processing is described. The apparatus may include one or more memories storing processor executable code, and one or more processors coupled with the one or more memories. The one or more processors may individually or collectively be operable to execute the code to cause the apparatus to receive first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units, receive second user input that indicates a first business unit of the set of multiple business units to assign to the first object, where the first business unit corresponds to a first partition of the cloud data storage system, configure the first object, based on the second user input, to utilize data from the first partition that corresponds to the first business unit, receive third user input to create a second object within the instance of the communication management application and associated with the first object, and configure the second object, based on the third user input to create the second object within the first object, to utilize the data from the first partition that corresponds to the first business unit.

Another apparatus for data processing is described. The apparatus may include means for receiving first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units, means for receiving second user input that indicates a first business unit of the set of multiple business units to assign to the first object, where the first business unit corresponds to a first partition of the cloud data storage system, means for configuring the first object, based on the second user input, to utilize data from the first partition that corresponds to the first business unit, means for receiving third user input to create a second object within the instance of the communication management application and associated with the first object, and means for configuring the second object, based on the third user input to create the second object within the first object, to utilize the data from the first partition that corresponds to the first business unit.

A non-transitory computer-readable medium storing code for data processing is described. The code may include instructions executable by one or more processors to receive first user input to create a first object within an instance of a communication management application associated with a set of multiple business units, where each business unit corresponds to a respective partition of a cloud data storage system that is accessible to the instance of the communication management application, and where each respective partition is configured to store data associated with a respective set of user entities associated with a corresponding business unit of the set of multiple business units, receive second user input that indicates a first business unit of the set of multiple business units to assign to the first object, where the first business unit corresponds to a first partition of the cloud data storage system, configure the first object, based on the second user input, to utilize data from the first partition that corresponds to the first business unit, receive third user input to create a second object within the instance of the communication management application and associated with the first object, and configure the second object, based on the third user input to create the second object within the first object, to utilize the data from the first partition that corresponds to the first business unit.

In some examples of the method, apparatus, and non-transitory computer-readable medium described herein, each business unit further corresponds to one or more content management resources for managing content communicated with the respective set of user entities associated with the business unit.

Some examples of the method, apparatus, and non-transitory computer-readable medium described herein may further include operations, features, means, or instructions for causing display, in a user interface, of one or more indications of one or more objects and a business unit corresponding to each of the one or more objects, the one or more objects including the first object that corresponds to the first business unit, where the first user input may be received in the user interface.

Some examples of the method, apparatus, and non-transitory computer-readable medium described herein may further include operations, features, means, or instructions for causing display, in the user interface, of an indication of a third object that may be not associated with a business unit, where the third object utilizes data from a third partition of the cloud data storage system associated with the instance of the communication management application.

Some examples of the method, apparatus, and non-transitory computer-readable medium described herein may further include operations, features, means, or instructions for receiving fourth user input to create a third object within the instance of the communication management application, receiving fifth user input that indicates a second business unit of the set of multiple business units to assign to the third object, and configuring, in response to receiving the second user input, the second object to utilize data from a second partition within the cloud data storage system, the second partition configured to store second data associated with a second set of user entities corresponding to the second business unit.

In some examples of the method, apparatus, and non-transitory computer-readable medium described herein, the set of multiple business units associated with the instance of the communication management application may be based on an access level of a user of the instance of the communication management application with respect to each business unit of the set of multiple business units.

Some examples of the method, apparatus, and non-transitory computer-readable medium described herein may further include operations, features, means, or instructions for receiving, from an administrative user, fourth user input that indicates the access level of the user with respect to each business unit of the set of multiple business units.

In some examples of the method, apparatus, and non-transitory computer-readable medium described herein, the set of multiple business units excludes one or more business units associated with a related instance of the communication management application based on the access level of the user with respect to the one or more business units.

Some examples of the method, apparatus, and non-transitory computer-readable medium described herein may further include operations, features, means, or instructions for displaying an indication of the first business unit in one or more user interfaces of the communication management application for configuring the first object or the second object based on the first object being configured to utilize data from the first partition associated with the first business unit.

Some examples of the method, apparatus, and non-transitory computer-readable medium described herein may further include operations, features, means, or instructions for receiving fourth user input to create the first business unit, causing display, in response to receiving the fourth user input, of a user interface that includes a name input field, a partition selection field, and a content management resource selection field, receiving fifth user input in the name input field that indicates a name of the first business unit, receiving sixth user input in the partition selection field that indicates the first partition to assign to the first business unit from one or more partitions associated with the instance of the communication management application, receiving seventh user input in the content management resource selection field that indicates one or more content management resources to assign to the first business unit, and configuring the first partition to store the data associated with a set of user entities associated with the first business unit.

Some examples of the method, apparatus, and non-transitory computer-readable medium described herein may further include operations, features, means, or instructions for receiving fourth user input configuring one or more first communication settings associated with the first business unit that may be different than one or more second communication settings associated with a second business unit of the set of multiple business units.

Some examples of the method, apparatus, and non-transitory computer-readable medium described herein may further include operations, features, means, or instructions for causing display, in a user interface associated with a second business unit corresponding to a second partition of the cloud data storage system, analytic information associated with the first business unit and a third business unit of the set of multiple business units based on the second partition receiving first data associated with a first set of user entities associated with the first business unit and receiving second data associated with a second set of clients associated with the third business unit.

Some examples of the method, apparatus, and non-transitory computer-readable medium described herein may further include operations, features, means, or instructions for transmitting one or more electronic communications to a user entity based on the first object, the second object, or both, in accordance with the data stored in the first partition based on configuring the first object to utilize the data stored at the first partition that corresponds to the first business unit.

The following provides an overview of aspects of the present disclosure:

Aspect 1: A method for data processing, comprising: causing display of a user interface associated with an instance of a communication management application, wherein the user interface includes a partition selection field for indicating a partition of one or more partitions of a cloud data storage system that are accessible via the instance of the communication management application; receiving first user input in the partition selection field indicating the partition to assign to the instance of the communication management application; configuring, in response to receiving the first user input, the instance of the communication management application to access the partition indicated by the first user input; and configuring an object within the instance of the communication management application to utilize data from the partition based at least in part on configuring the instance of the communication management application to utilize the partition.

Aspect 2: The method of aspect 1, further comprising: provisioning the one or more partitions of the cloud data storage system to a user of the instance of the communication management application based at least in part on an access level of the user with respect to each partition of the one or more partitions, wherein the first user input is based at least in part on provisioning the one or more partitions to the user.

Aspect 3: The method of any of aspects 1 through 2, further comprising: receiving, from a first user of a second instance of the communication management application, fourth user input to provision the partition to the instance of the communication management application; receiving, from a second user of the instance of the communication management application and based at least in part on the fourth user input, fifth user input that indicates a confirmation associated with provisioning the partition; and provisioning the partition to the instance of the communication management application based at least in part on the confirmation.

Aspect 4: The method of any of aspects 1 through 3, wherein the one or more partitions of the cloud data storage system include a default partition associated with instantiation of the instance of the communication management application and a non-default partition that is provisioned after the instantiation of the instance of the communication management application.

Aspect 5: The method of aspect 4, wherein the partition to assign to the instance of the communication management application comprises the non-default partition that is provisioned after the instantiation of the instance of the communication management application.

Aspect 6: The method of any of aspects 1 through 5, further comprising: causing display, in response to receiving the first user input, of one or more user interface components that indicate one or more operations associated with configuring the instance of the communication management application to utilize the partition indicated by the first user input.

Aspect 7: The method of any of aspects 1 through 6, wherein configuring the instance of the communication management application to access the partition comprises: receiving one or more fourth user inputs to initiate installation of one or more data kits associated with the partition.

Aspect 8: The method of any of aspects 1 through 7, further comprising: transmitting, based at least in part on the object, one or more electronic communications to a user entity in accordance with data stored in the partition based at least in part on configuring the instance of the communication management application to access the partition indicated by the first user input.

Aspect 9: A method for data processing, comprising: receiving first user input to create a first object within an instance of a communication management application associated with a plurality of business units, wherein each business unit corresponds to a respective partition of a cloud data storage system that is accessible to the instance of the communication management application, and wherein each respective partition is configured to store data associated with a respective set of user entities associated with a corresponding business unit of the plurality of business units; receiving second user input that indicates a first business unit of the plurality of business units to assign to the first object, wherein the first business unit corresponds to a first partition of the cloud data storage system; configuring the first object, based at least in part on the second user input, to utilize data from the first partition that corresponds to the first business unit; receiving third user input to create a second object within the instance of the communication management application and associated with the first object; and configuring the second object, based at least in part on the third user input to create the second object within the first object, to utilize the data from the first partition that corresponds to the first business unit.

Aspect 10: The method of aspect 9, wherein each business unit further corresponds to one or more content management resources for managing content communicated with the respective set of user entities associated with the business unit.

Aspect 11: The method of any of aspects 9 through 10, further comprising: causing display, in a user interface, of one or more indications of one or more objects and a business unit corresponding to each of the one or more objects, the one or more objects comprising the first object that corresponds to the first business unit, wherein the first user input is received in the user interface.

Aspect 12: The method of aspect 11, further comprising: causing display, in the user interface, of an indication of a third object that is not associated with a business unit, wherein the third object utilizes data from a third partition of the cloud data storage system associated with the instance of the communication management application.

Aspect 13: The method of any of aspects 9 through 12, further comprising: receiving fourth user input to create a third object within the instance of the communication management application; receiving fifth user input that indicates a second business unit of the plurality of business units to assign to the third object; and configuring, in response to receiving the second user input, the second object to utilize data from a second partition within the cloud data storage system, the second partition configured to store second data associated with a second set of user entities corresponding to the second business unit.

Aspect 14: The method of any of aspects 9 through 13, wherein the plurality of business units associated with the instance of the communication management application is based at least in part on an access level of a user of the instance of the communication management application with respect to each business unit of the plurality of business units.

Aspect 15: The method of aspect 14, further comprising: receiving, from an administrative user, fourth user input that indicates the access level of the user with respect to each business unit of the plurality of business units.

Aspect 16: The method of any of aspects 14 through 15, wherein the plurality of business units excludes one or more business units associated with a related instance of the communication management application based at least in part on the access level of the user with respect to the one or more business units.

Aspect 17: The method of any of aspects 9 through 16, further comprising: displaying an indication of the first business unit in one or more user interfaces of the communication management application for configuring the first object or the second object based at least in part on the first object being configured to utilize data from the first partition associated with the first business unit.

Aspect 18: The method of any of aspects 9 through 17, further comprising: receiving fourth user input to create the first business unit; causing display, in response to receiving the fourth user input, of a user interface that includes a name input field, a partition selection field, and a content management resource selection field; receiving fifth user input in the name input field that indicates a name of the first business unit; receiving sixth user input in the partition selection field that indicates the first partition to assign to the first business unit from one or more partitions associated with the instance of the communication management application; receiving seventh user input in the content management resource selection field that indicates one or more content management resources to assign to the first business unit; and configuring the first partition to store the data associated with a set of user entities associated with the first business unit.

Aspect 19: The method of any of aspects 9 through 18, further comprising: receiving fourth user input configuring one or more first communication settings associated with the first business unit that are different from one or more second communication settings associated with a second business unit of the plurality of business units.

Aspect 20: The method of any of aspects 9 through 19, further comprising: causing display, in a user interface associated with a second business unit corresponding to a second partition of the cloud data storage system, analytic information associated with the first business unit and a third business unit of the plurality of business units based at least in part on the second partition receiving first data associated with a first set of user entities associated with the first business unit and receiving second data associated with a second set of clients associated with the third business unit.

Aspect 21: The method of any of aspects 9 through 20, further comprising: transmitting one or more electronic communications to a user entity based at least in part on the first object, the second object, or both, in accordance with the data stored in the first partition based at least in part on configuring the first object to utilize the data stored at the first partition that corresponds to the first business unit.

Aspect 22: An apparatus for data processing, comprising one or more memories storing processor-executable code, and one or more processors coupled with the one or more memories and individually or collectively operable to execute the code to cause the apparatus to perform a method of any of aspects 1 through 8.

Aspect 23: An apparatus for data processing, comprising at least one means for performing a method of any of aspects 1 through 8.

Aspect 24: A non-transitory computer-readable medium storing code for data processing, the code comprising instructions executable by one or more processors to perform a method of any of aspects 1 through 8.

Aspect 25: An apparatus for data processing, comprising one or more memories storing processor-executable code, and one or more processors coupled with the one or more memories and individually or collectively operable to execute the code to cause the apparatus to perform a method of any of aspects 9 through 21.

Aspect 26: An apparatus for data processing, comprising at least one means for performing a method of any of aspects 9 through 21.

Aspect 27: A non-transitory computer-readable medium storing code for data processing, the code comprising instructions executable by one or more processors to perform a method of any of aspects 9 through 21.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
causing display of a user interface associated with an instance of a communication management application, wherein the user interface includes a partition selection field for indicating a partition of one or more partitions of a cloud data storage system that are accessible via the instance of the communication management application;
receiving first user input in the partition selection field indicating the partition to assign to the instance of the communication management application;
configuring, in response to receiving the first user input, the instance of the communication management application to access the partition indicated by the first user input; and
configuring an object within the instance of the communication management application to utilize data from the partition based at least in part on configuring the instance of the communication management application to utilize the partition.

2. The method of claim 1, further comprising:
provisioning the one or more partitions of the cloud data storage system to a user of the instance of the communication management application based at least in part on an access level of the user with respect to each partition of the one or more partitions, wherein the first user input is based at least in part on provisioning the one or more partitions to the user.

3. The method of claim 1, further comprising:
receiving, from a first user of a second instance of the communication management application, fourth user input to provision the partition to the instance of the communication management application;
receiving, from a second user of the instance of the communication management application and based at least in part on the fourth user input, fifth user input that indicates a confirmation associated with provisioning the partition; and
provisioning the partition to the instance of the communication management application based at least in part on the confirmation.

4. The method of claim 1, wherein the one or more partitions of the cloud data storage system include a default partition associated with instantiation of the instance of the communication management application and a non-default partition that is provisioned after the instantiation of the instance of the communication management application.

5. The method of claim 4, wherein the partition to assign to the instance of the communication management application comprises the non-default partition that is provisioned after the instantiation of the instance of the communication management application.

6. The method of claim 1, further comprising:
causing display, in response to receiving the first user input, of one or more user interface components that indicate one or more operations associated with configuring the instance of the communication management application to utilize the partition indicated by the first user input.

7. The method of claim 1, wherein configuring the instance of the communication management application to access the partition comprises:
receiving one or more fourth user inputs to initiate installation of one or more data kits associated with the partition.

8. The method of claim 1, further comprising:
transmitting, based at least in part on the object, one or more electronic communications to a user entity in accordance with data stored in the partition based at least in part on configuring the instance of the communication management application to access the partition indicated by the first user input.

9. An apparatus for data processing, comprising:
one or more memories storing processor-executable code; and
one or more processors coupled with the one or more memories and individually or collectively operable to execute the code to cause the apparatus to:
cause display of a user interface associated with an instance of a communication management application, wherein the user interface includes a partition selection field for indicating a partition of one or more partitions of a cloud data storage system that are accessible via the instance of the communication management application;
receive first user input in the partition selection field indicating the partition to assign to the instance of the communication management application;
configure, in response to receive the first user input, the instance of the communication management application to access the partition indicated by the first user input; and
configure an object within the instance of the communication management application to utilize data from the partition based at least in part on configuring the instance of the communication management application to utilize the partition.

10. The apparatus of claim 9, wherein the one or more processors are individually or collectively further operable to execute the code to cause the apparatus to:
provision the one or more partitions of the cloud data storage system to a user of the instance of the communication management application based at least in part on an access level of the user with respect to each partition of the one or more partitions, wherein the first user input is based at least in part on provisioning the one or more partitions to the user.

11. The apparatus of claim 9, wherein the one or more processors are individually or collectively further operable to execute the code to cause the apparatus to:
receive, from a first user of a second instance of the communication management application, fourth user input to provision the partition to the instance of the communication management application;
receive, from a second user of the instance of the communication management application and based at least in part on the fourth user input, fifth user input that indicates a confirmation associated with provisioning the partition; and
provision the partition to the instance of the communication management application based at least in part on the confirmation.

12. The apparatus of claim 9, wherein the one or more partitions of the cloud data storage system include a default partition associated with instantiation of the instance of the communication management application and a non-default partition that is provisioned after the instantiation of the instance of the communication management application.

13. The apparatus of claim 12, wherein the partition to assign to the instance of the communication management application comprises the non-default partition that is provisioned after the instantiation of the instance of the communication management application.

14. The apparatus of claim 9, wherein the one or more processors are individually or collectively further operable to execute the code to cause the apparatus to:
cause display, in response to receiving the first user input, of one or more user interface components that indicate one or more operations associated with configuring the instance of the communication management application to utilize the partition indicated by the first user input.

15. The apparatus of claim 9, wherein, to configure the instance of the communication management application to access the partition, the one or more processors are individually or collectively operable to execute the code to cause the apparatus to:
receive one or more fourth user inputs to initiate installation of one or more data kits associated with the partition.

16. The apparatus of claim 9, wherein the one or more processors are individually or collectively further operable to execute the code to cause the apparatus to:
transmit, based at least in part on the object, one or more electronic communications to a user entity in accordance with data stored in the partition based at least in part on configuring the instance of the communication management application to access the partition indicated by the first user input.

17. A non-transitory computer-readable medium storing code for data processing, the code comprising instructions executable by one or more processors to:
cause display of a user interface associated with an instance of a communication management application, wherein the user interface includes a partition selection field for indicating a partition of one or more partitions of a cloud data storage system that are accessible via the instance of the communication management application;
receive first user input in the partition selection field indicating the partition to assign to the instance of the communication management application;
configure, in response to receive the first user input, the instance of the communication management application to access the partition indicated by the first user input; and
configure an object within the instance of the communication management application to utilize data from the partition based at least in part on configuring the instance of the communication management application to utilize the partition.

18. The non-transitory computer-readable medium of claim 17, wherein the instructions are further executable by the one or more processors to:
provision the one or more partitions of the cloud data storage system to a user of the instance of the communication management application based at least in part on an access level of the user with respect to each partition of the one or more partitions, wherein the first user input is based at least in part on provisioning the one or more partitions to the user.

19. The non-transitory computer-readable medium of claim 17, wherein the instructions are further executable by the one or more processors to:
receive, from a first user of a second instance of the communication management application, fourth user input to provision the partition to the instance of the communication management application;
receive, from a second user of the instance of the communication management application and based at least in part on the fourth user input, fifth user input that indicates a confirmation associated with provisioning the partition; and
provision the partition to the instance of the communication management application based at least in part on the confirmation.

20. The non-transitory computer-readable medium of claim 17, wherein the one or more partitions of the cloud data storage system include a default partition associated with instantiation of the instance of the communication management application and a non-default partition that is provisioned after the instantiation of the instance of the communication management application.
